(19) United States
(12) Patent Application Publication
(10) Pub. No.: US 2024/0328252 A1
(43) Pub. Date: Oct. 3, 2024

(54) VALIDATION OF SPRING-BALANCING OF A MOTORIZED WINDOW TREATMENT

(71) Applicant: Lutron Technology Company LLC, Coopersburg, PA (US)

(72) Inventors: Jonathan Edward Ely, Allentown, PA (US); David A. Leymeister, Allentown, PA (US); Ben Matzke, Doylestown, PA (US); Maxwell Ross Naar, Doylestown, PA (US); Sheng Qu, Allentown, PA (US); Robert J. Thompson, Bethlehem, PA (US)

(73) Assignee: Lutron Technology Company LLC, Coopersburg, PA (US)

(21) Appl. No.: 18/622,267

(22) Filed: Mar. 29, 2024

Related U.S. Application Data
(60) Provisional application No. 63/493,562, filed on Mar. 31, 2023.
(60) Provisional application No. 63/600,305, filed on Nov. 17, 2023.

(51) Int. Cl. E06B 9/72; E06B 9/262; E06B 9/60; E06B 9/68

(52) U.S. Cl. CPC E06B 9/72; E06B 9/262; E06B 9/60; E06B 2009/2622; E06B 2009/6854

(57) ABSTRACT

A motor drive unit for a system for raising and lowering a covering material (e.g., a window treatment system) may be configured to execute a test procedure for determining if the system is spring-balanced properly. The motor drive unit may be powered from at least one battery. The system may comprise one or more lift assistance springs configured to provide variable lift assistance to the motor drive unit for raising and lowering the covering material. During the test procedure, the motor drive unit may be configured to control the covering material between a lowered position and a raised position and determine a magnitude of an input power of the motor drive unit during the movement. The motor drive unit may determine that the system requires more or less lift assistance springs based on the input power, and communicate an indication that the system requires more or less lift assistance springs.

### CROSS-REFERENCE TO RELATED APPLICATIONS

This application claims the benefit of Provisional U.S. Patent Application No. 63/493,562, filed Mar. 31, 2023, and Provisional U.S. Patent Application No. 63/600,305, filed Nov. 17, 2023, entire disclosures of which are hereby incorporated by reference herein in their entirety.

### BACKGROUND

Typical window treatments (e.g., such as, for example, roller shades, draperies, Roman shades, and Venetian blinds) may be mounted in front of windows to prevent sunlight from entering a space and/or to provide privacy. Many types of window treatments may be moved between a raised position (e.g., a fully-raised position and/or an open position) and a lowered position (e.g., a fully-lowered position and/or a closed position), as well placed in any number of positions between the raised and lowered positions. The actuation of the window treatments may be manual or powered. For powered systems, which use a motor to control the movement of the window treatments, the motor may be powered by a power source. The power source may be a fixed power source, e.g., an alternating-current (AC) source or a direct-current (DC) power source connected to the internal electrical wiring of the dwelling (e.g., home, office, etc.), or may be from a temporary or replaceable power source, such as a battery.

### SUMMARY

As described herein, a motor drive unit for a system for raising a lowering a covering material, such as a window treatment system, may be configured to execute a test procedure for determining if the window treatment system is spring-balanced properly. The motor drive unit may adjust a position of the covering material between a lowered position (e.g., a fully-lowered position) and a raised position (e.g., a fully-raised position). The window treatment system may comprise first and second brackets for mounting the window treatment system to a structure. The window treatment system may also comprise one or more lift assistance springs configured to provide lift assistance to the motor drive unit and a battery holder configured to receive at least one battery for powering the motor drive unit. During the test procedure, the motor drive unit may be configured to control the position of the covering material through a movement between the lowered position and the raised position, and determine a magnitude of an input power of the motor drive unit as consumed from the at least one battery during the movement of the covering material between the lowered position and the raised position. The motor drive unit may be configured to determine that the window treatment system requires more or less lift assistance springs based on the input power of the motor drive unit during the movement of the covering material between the lowered position and the raised position, and communicate an indication that the window treatment system requires more or less lift assistance springs in response to determining that the window treatment system requires more or less lift assistance springs.

In one example, during the test procedure, the motor drive unit may be configured to control the covering material from the lowered position to the raised position, and determine a maximum raising power while the motor drive unit is controlling the covering material from the lowered position to the raised position. In addition, the motor drive unit may be configured to control the covering material from the raised position to the lowered position, and determine a maximum lowering power while the motor drive unit is controlling the covering material from the raised position to the lowered position. The motor drive unit may be configured to determine that the window treatment system requires more or less lift assistance springs when a difference between the maximum raising power and the maximum lowering power is greater than a threshold. When the maximum raising power is greater than the maximum lowering power, the indication that the window treatment system requires more or less lift assistance springs may be an indication that the window treatment system requires more lift assistance springs. When the maximum lowering power is greater than the maximum raising power, the indication that the window treatment system requires more or less lift assistance spring may be an indication that the window treatment system requires less lift assistance springs. Further, the indication that the window treatment system requires more or less lift assistance springs may be an indication that the difference between the maximum raising power and the maximum lowering power is greater than the threshold.

In another example, during the test procedure, the motor drive unit may be configured to determine that the window treatment system requires more or less lift assistance springs when the magnitude of the input power is greater than a threshold during the movement of the covering material between the lowered position and the raised position. During the test procedure, the motor drive unit may be configured to control the covering material from the lowered position to the raised position, and determine the magnitude of the input power of the motor drive unit during the movement of the covering material from the lowered position to the raised position. When the magnitude of the input power is greater than the threshold during the movement of the covering material from lowered position to the raised position, the indication that the window treatment system requires more or less lift assistance springs may be an indication that the window treatment system requires more lift assistance springs. During the test procedure, the motor drive unit may be configured to control the covering material from the raised position to the lowered position, and determine the magnitude of the input power of the motor drive unit during the movement of the covering material from the raised position to the lowered position. When the magnitude of the input power is greater than the threshold during the movement of the covering material from raised position to the lowered position, the indication that the window treatment system requires more or less lift assistance springs may be an indication that the window treatment system requires less lift assistance springs. In addition, the indication that the window treatment system requires more or less lift assistance springs may be an indication that the magnitude of the input power is greater than the threshold during the movement of the covering material between the lowered position and the raised position.

the motor drive unit may be configured to control the covering material from the lowered position to the raised position, and also control the covering material from the raised position to the lowered position. When the magnitude of the input power is greater than the threshold during the movement of the covering material from lowered position to the raised position, the motor drive unit may communicate an indication that the window treatment system requires more lift assistance springs. When the magnitude of the input power is greater than a lower-movement threshold during the movement of the covering material from raised position to the lowered position, the motor drive unit may communicate an indication that the window treatment system requires less lift assistance springs.

The motor drive unit may be configured to execute the test procedure in response to receiving an input. For example, the motor drive unit may be configured to execute the test procedure in response to receiving a message. The motor drive unit may be configured to be paired with a remote control device and execute the test procedure in response to receiving the message from the remote control device via one or more wireless signals. The motor drive unit may also be configured to execute the test procedure in response to receiving the message using a short-range wireless communication protocol. In addition, the motor drive unit may be configured to execute the test procedure in response to an actuation of a button on the motor drive unit.

In addition, the motor drive unit may be configured to communicate a result of the test procedure. For example, the motor drive unit may be configured to communicate an indication that the window treatment system requires more lift assistance springs and/or an indication that the window treatment system requires less lift assistance springs. For example, the motor drive unit may be configured to communicate the indication that the result of the test procedure by blinking a visible indicator of the motor drive unit with a unique blink pattern. In addition, the motor drive unit may be configured to communicate the indication that the result of the test procedure by transmitting a message including the indication of the result of the test procedure.

### BRIEF DESCRIPTION OF THE DRAWINGS

FIG. 1 is a front perspective view of a Roman shade system in a lowered position (e.g., a fully-lowered position).

FIG. 2 is a rear perspective view of the Roman shade system of FIG. 1 in the lowered position.

FIG. 3 is a front perspective view of the Roman shade system of FIG. 1 in a raised position (e.g., a fully-raised position).

FIG. 4 is a perspective view of an example of a head rail assembly of the Roman shade system of FIG. 1 where the Roman shade system comprises a single lift ring for each cord.

FIG. 5 is a perspective view of the head rail assembly of FIG. 4 where the Roman shade system comprises a pair of lift rings for each cord.

FIG. 6 is a perspective view of the head rail assembly of FIG. 4 where the Roman shade system comprises a pair of lift rings for attaching a ribbon to a roller tube of the head rail assembly.

FIG. 7 is a front view of the head rail assembly of FIG. 4.

FIG. 8A is an exploded view of the head rail assembly of FIG. 4 when a lift assistance subsystem of the head rail assembly comprises a single lift assistance spring.

FIG. 8B is a partial exploded view of the head rail assembly of FIG. 4 when a lift assistance subsystem of the head rail assembly comprises multiple lift assistance springs.

FIG. 9 is a perspective view of an example motor drive unit of the head rail assembly of FIG. 4.

FIG. 10 is a left-side perspective view of the head rail assembly of FIG. 4 with brackets removed.

FIG. 11 is a right-side perspective view of the head rail assembly of FIG. 4 with brackets removed.

FIG. 12 is a right-side view of a Roman shade system that includes the head rail assembly of FIGS. 4-11 when the Roman shade system is in a front-control configuration.

FIG. 13 is a right-side view of a Roman shade system that includes the head rail assembly of FIGS. 4-11 when the Roman shade system is in a rear-control configuration.

FIG. 14 is a partial exploded view of the head rail assembly of FIGS. 4-11 showing a bracket, a lift assistance subsystem, and a gear assembly of the head rail assembly in greater detail.

FIG. 15 is a flowchart of an example fabrication procedure for building a window treatment system, such as the Roman shade system of FIG. 1.

FIG. 16 is a block diagram of a motor drive unit of a motorized window treatment of a window treatment system.

FIG. 17 show a flowchart of an example test procedure for verifying proper spring-balancing of a window treatment system.

FIGS. 18A and 18B show a flowchart of another example test procedure for verifying proper spring-balancing of a window treatment system.

### DETAILED DESCRIPTION

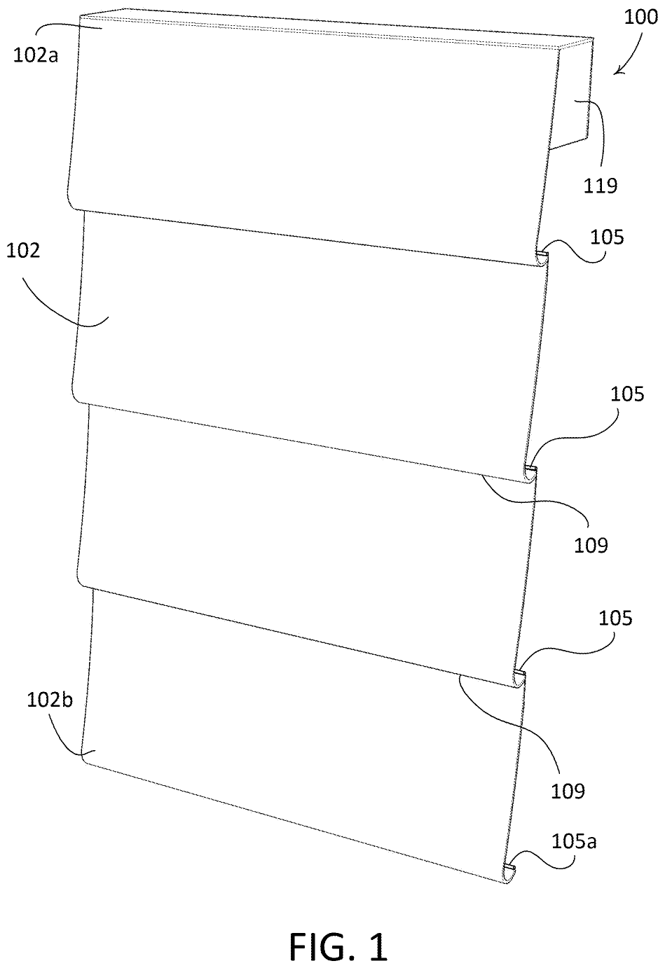

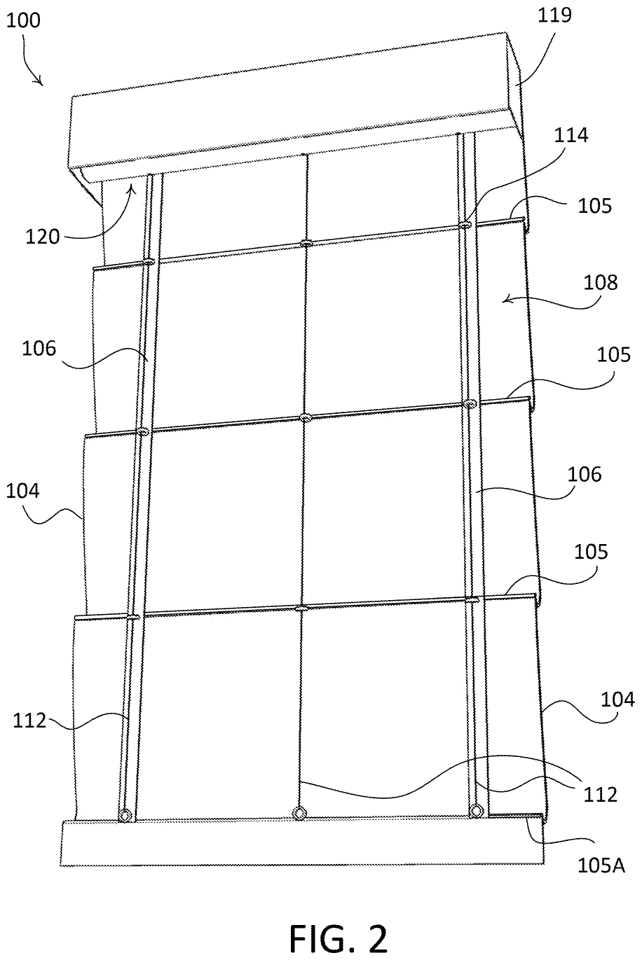

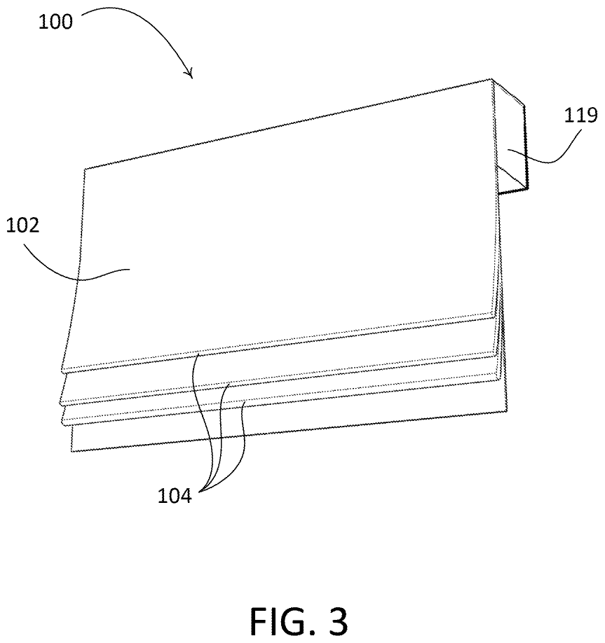

FIG. 1 is a front perspective view and FIG. 2 is a rear perspective view of a window treatment system, such as a Roman shade system 100, in lowered position, such as a lowered position (e.g., a fully-lowered and/or a closed position). FIG. 3 is a front perspective view of the Roman shade system 100 in a raised position, such as a raised position (e.g., a fully-raised position and/or an open position). The Roman shade system 100 may include a covering material, such as a shade fabric 102. The shade fabric 102 may come in different sizes, materials, and/or styles (e.g., such as a hobbled shade fabric as shown in FIG. 1-3). The variation in the size, material, and/or style of the shade fabric 102 of the Roman shade system 100 may lead to a variation in the weight of the shade fabric 102 from one installation to the next.

When the shade fabric 102 is a hobbled shade fabric as shown in FIGS. 1-3, the shade fabric 102 may be adapted to fold into a plurality of pleats 104 (e.g., horizontal pleats) as the Roman shade system 100 is opened. The pleats 104 may be formed by rigid battens 105 (e.g., dowels), which are sewn into the shade fabric 102 and extend horizontally across the width of the shade fabric. The Roman shade system 100 may comprise two or more ribbons 106 that extend along the length of a rear surface 108 of the shade fabric 102 and are attached to the rear surface 108 of the shade fabric 102 at the battens. Accordingly, the shade fabric 102 (e.g., the hobbled shade fabric) may hang with a plurality of folds 109 when the Roman shade system 100 is in the lowered position as shown in FIGS. 1 and 2. The Roman shade system 100 may include one or more flexible members, such as cords 112 (e.g., three cords as shown in FIG. 2), which allow for raising and lowering of the shade fabric 102. The cords 112 may be attached to a lowest one 105a of the battens 105 and pass through a plurality of eyelets 114 (e.g., attachment points) that are coupled to the rear surface 108 of the shade fabric 102. The eyelets 114 may be coupled to the battens. Although three cords 112 are illustrated, it should be understood that fewer (e.g., one or two) or more cords may be used.

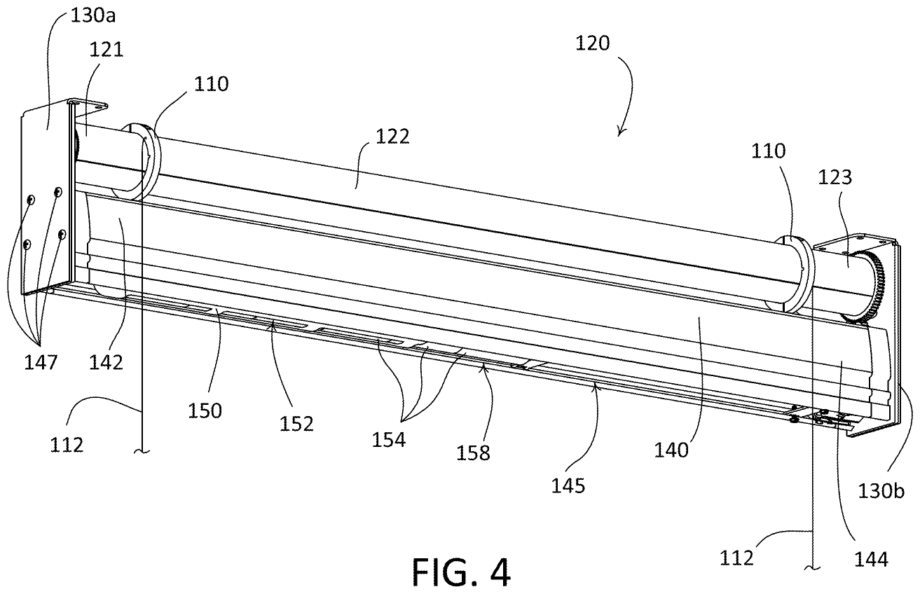

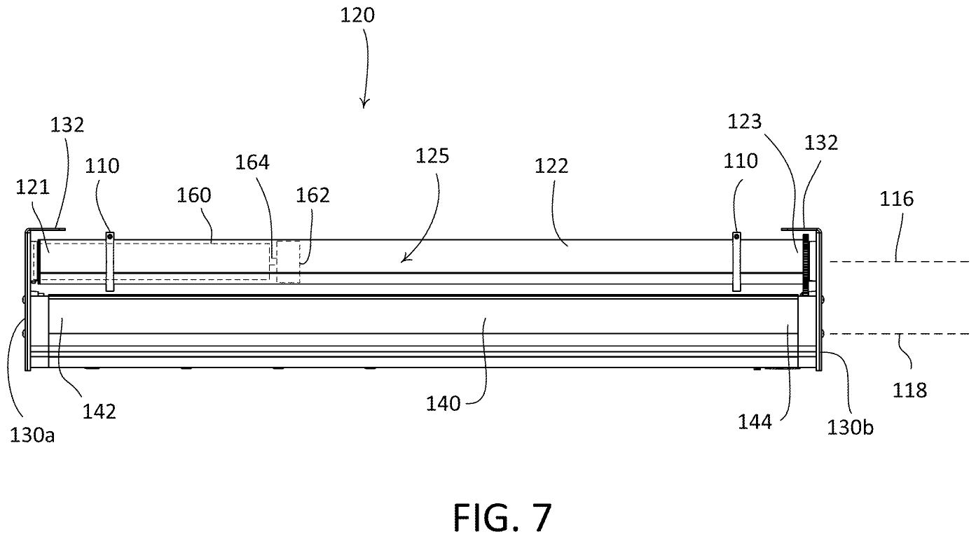

The Roman shade system 100 may comprise a head rail assembly 120, which may be located in an enclosure 119 (e.g., as shown in FIG. 2). FIG. 4 is a perspective view of the head rail assembly 120. The head rail assembly 120 may comprise a roller tube 122 that may be configured to rotate about a first axis 116 (FIG. 7), which may be a longitudinal axis of the roller tube 122. The roller tube 122 may extend from a first end 121 to a second end 123. As shown in FIGS. 1-3, the shade fabric 102 (e.g., a top end 102a of the shade fabric 102) may be attached (e.g., fixedly attached) to the enclosure 119 surrounding the head rail assembly 120 and may be configured to hang from the enclosure 119 (e.g., for covering an opening, such as a window). The cords 112 may be coupled to the roller tube 122 of the head rail assembly 120. The cords 112 may be configured to wrap around the roller tube 122 and a bottom end 102b of the shade fabric 102 may be configured to move as the roller tube 122 rotates. The enclosure 119 may hide the head rail assembly 120 from view. While the Roman shade system 100 is shown with the head rail assembly 120 located in the enclosure 119 in FIGS. 1-3, the head rail assembly 120 may also be installed without the enclosure 119 and the top end of the shade fabric 102 may be attached to a portion of the structure of the building around the head rail assembly 120.

The Roman shade system 100 may comprise one or more lift rings 110 (e.g., cord guides and/or collars), coupled to the roller tube 122 for guiding the cords 112 as the cords wind around and unwind from the roller tube 122. The lift rings 110 may each extend around the roller tube 122. For example, the Roman shade system 100 may comprise one lift ring 110 (e.g., a single lift ring) for each of the cords 112 of the Roman shade system 100. Each cord 112 may be attached to the respective lift ring 110 (e.g., such as at an inner side of the left lift ring 110 near the roller tube 122) and may extend from the lift ring 110 such that the cord 112 wraps around the roller tube 122 adjacent to one side of the respective lift ring 110 as the roller tube 122 rotates. While two lift rings 110 are shown in FIG. 4, the Roman shade system 100 may comprise more than two lift rings 110 around the roller tube 122 depending on the number of cords 112 required for the shade fabric 102 (e.g., one lift ring 110 for each cord 112).

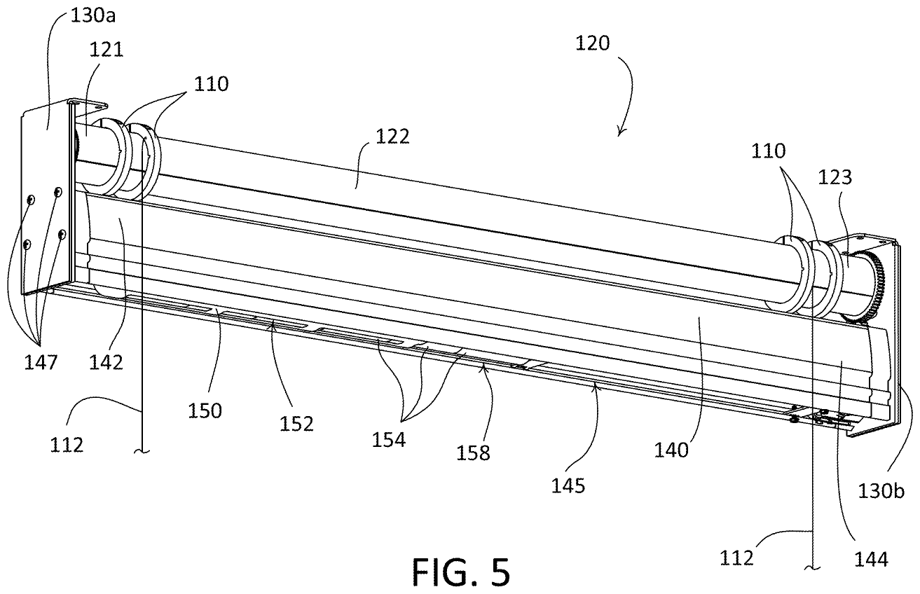

In addition, the Roman shade system 100 may comprise a pair of lift rings 110 for each of the cords 112 in the Roman shade system 100, e.g., as shown in FIG. 5. The lift rings 110 of each pair of lift rings 110 may be spaced apart from each other along the roller tube 122. Each cord 112 may be attached to one of the lift rings 110 of each pair of lift rings 110, and may extend from the lift ring 110 such that the cords 112 may wrap around the roller tube 122 between the pair of lift rings 110 as the roller tube 122 rotates. While two pairs of lift rings 110 are shown in FIG. 5, the Roman shade system 100 may comprise more than two pairs of lift rings 110 around the roller tube 126 depending on the number of cords 112 required for the shade fabric 102 (e.g., one pair of lift rings 110 for each cord 112).

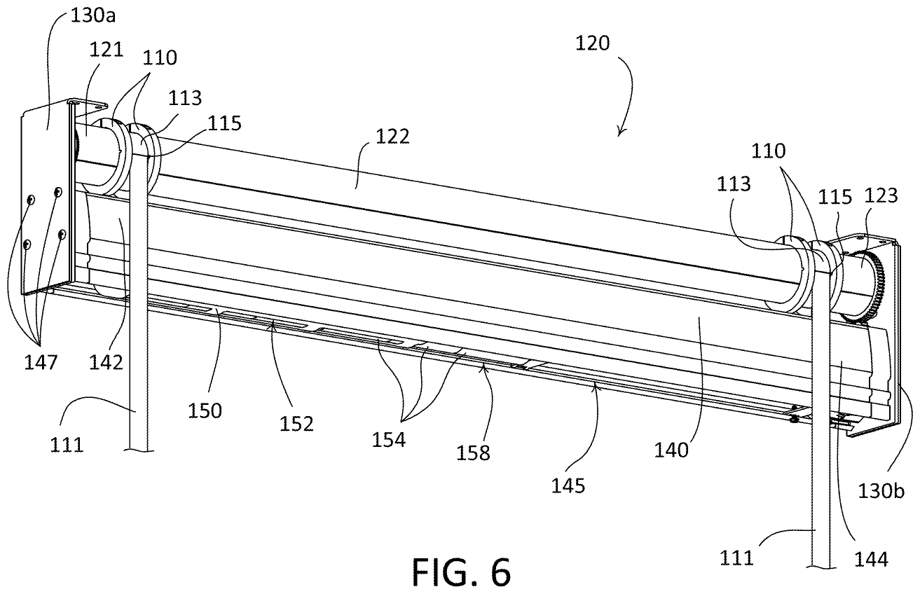

Further, rather than using the cords 112, the Roman shade system 100 may comprise one or more flexible members, such as ribbons 111 (e.g., straps) as shown in FIG. 6. For example, the ribbons 111 may have a narrow width (e.g., approximately ¼ inch or less). The ribbons 111 may each wrap around the roller tube 122 between adjacent lift rings 110 of each pair of lift rings 110. The Roman shade system 100 may comprise a pair of lift rings 110 for each of the ribbons 111 in the Roman shade system 100. Each ribbon 111 may be attached to a pin 113 (e.g., a rod) at one end of the ribbon 111. The pin 113 may be configured to be received in respective channels 115 in the lift rings 110 of each pair of lift rings 110. The lift rings 110 (of each pair of lift rings 110) may be spaced apart from each other along the roller tube 122, such that the pin 113 extends between the adjacent lift rings 110 and the ribbons 111 wrap around the roller tube 122 between the lift rings 110 as the roller tube 122 rotates. While two ribbons 111 and two pairs of lift rings 110 are shown in FIG. 6, the Roman shade system 100 may comprise more than two ribbons 111 and respective pairs of lift rings 110 around the roller tube 126 depending on the number of ribbons 111 required for the shade fabric 102 (e.g., one pair of lift rings 110 for each ribbon 111).

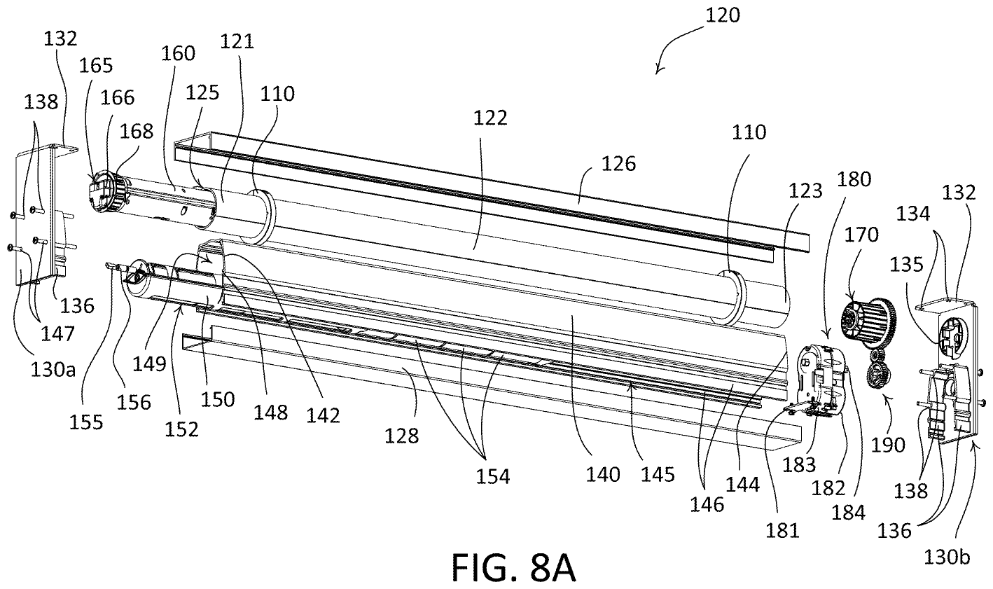

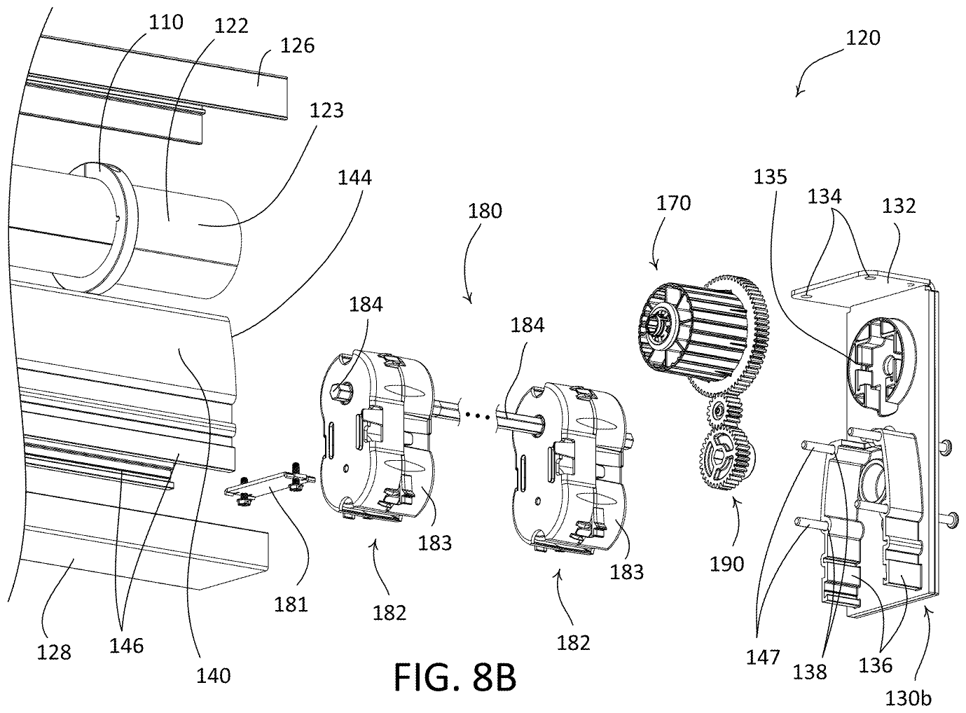

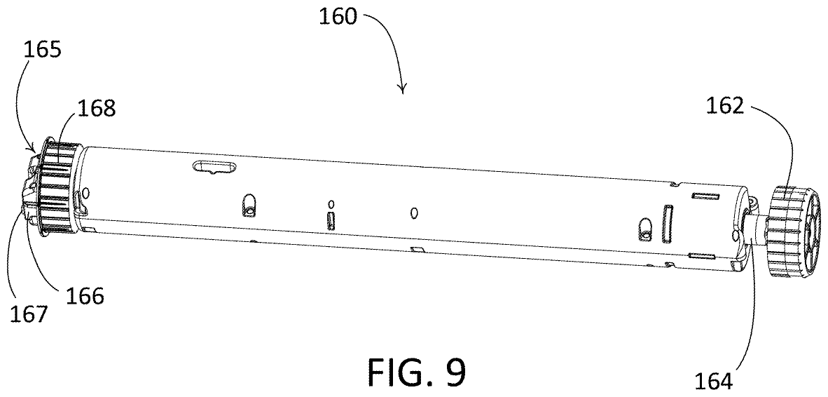

FIG. 7 is a front view is an exploded view of the head rail assembly 120. FIGS. 8 and 9 are exploded views of the head rail assembly 120. The roller tube 122 may be hollow such that the roller tube 122 defines an internal cavity 125 sized and configured to receive a motor drive unit 160 (e.g., a motor drive assembly) as shown in FIG. 7. For example, the position of the motor drive unit 160 in the roller tube 122 may be illustrated by a dashed line in FIG. 7. The motor drive unit 160 may be received in the first end 121 of the roller tube 122. One example of a motor drive unit is disclosed in U.S. Pat. No. 6,983,783, issued Jan. 10, 2006, entitled MOTORIZED SHADE CONTROL SYSTEM, the entire disclosure of which is hereby incorporated by reference.

FIG. 9 is a perspective view of the motor drive unit 160 removed from the roller tube 122. The motor drive unit 160 may include an internal motor (not shown) that may be coupled to a drive coupler 162 via a drive shaft 164 for rotatably driving the drive coupler 162. The drive coupler 162 may be notched about its outer periphery to facilitate engagement between the drive coupler 162 and an interior surface of the roller tube 122 in which the motor drive unit 160 is received. The motor drive unit 160 may further comprise an end portion 165 having a connector 166, such as a male or female connector, for connecting the motor drive unit 160 to a power source, such as one or more batteries 154 (e.g., as will be described in greater detail below). The end portion 165 may also have at least one button 167 for receiving user inputs and a visible indicator (not shown) that may be illuminated for providing feedback to a user of the Roman shade system 100. The motor drive unit 160 may comprise a bearing assembly 168, which may be rotatably coupled to the roller tube 122 at the first end 121 of the roller tube 122. The second end 123 of the roller tube 120 may receive an idler assembly 170 (FIG. 8A), which may be rotatably coupled to the roller tube 120 at the second end 123 of the roller tube 120. The motor drive unit 160 may be configured to transmit and/or receive messages (e.g., digital messages) via signals (e.g., wireless signals, such as radio-frequency signals), such that the motor drive unit 160 may be configured to rotate the roller tube 122 for raising and/or lowering the shade fabric 102 in response to received messages.

The head rail assembly 120 may also include a first bracket 130a and a second bracket 130b for mounting the Roman shade system 100 to a structure (e.g., a wall, a ceiling, a window frame, or other structure to which the Roman shade system is to be coupled). For example, the brackets 130a, 130b may each include a flange 132 defining holes 134. The holes 134 may be sized and configured to receive fasteners (e.g., screws) for coupling the brackets 130a, 130b to the structure. The first and second brackets 130a, 130b may be configured to support (e.g., rotatably support) the roller tube 122 (e.g., via a bearing assembly of the motor drive unit 160 and the idler assembly 170). The first bracket 130a may be coupled to the end portion 165 of the motor drive unit 160 and the second bracket 130b may be coupled to the idler assembly 170 to support (e.g., rotatably support) the roller tube 122. The first and second brackets 130a, 130b may comprise respective attachment structures for attaching to the end portion 165 of the motor drive unit 160 and the idler assembly 170, respectively. For example, the second bracket 130b may comprise an attachment structure 135 configured to attach to and support the idler assembly 170 (e.g., as shown in FIG. 8A). The first bracket 130a may comprise a corresponding attachment structure (not shown) configured to attach to and support the end portion 165 of the motor drive unit 160.

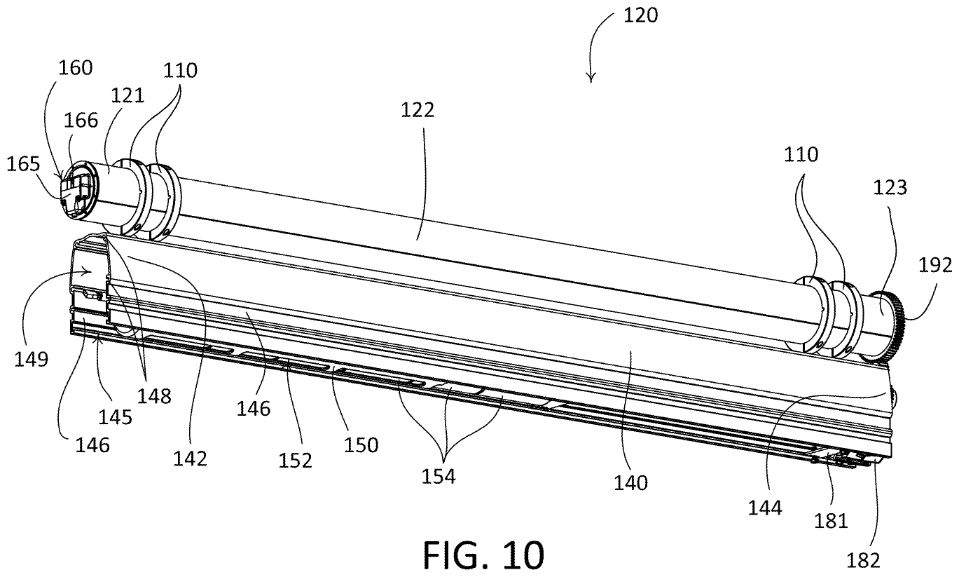

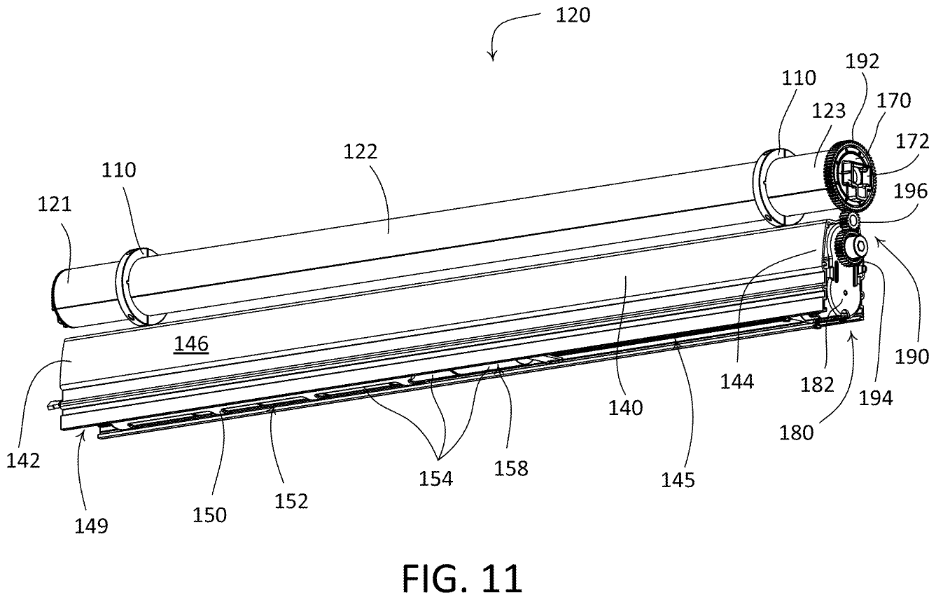

FIG. 10 is a left-side perspective view and FIG. 11 is a right-side perspective view of the head rail assembly 120 with the brackets 130a, 130b removed. The head rail assembly 120 may further include a housing 140 (e.g., an elongated housing or body), which extends from a first end 142 to a second end 144 (e.g., extends the length of the roller tube 122). The housing 140 may comprise sidewalls 146 that extend the length of the housing 140 from the first end 142 to the second end 144. The housing 140 may define an elongated slot 145 that may extend the length of the housing 140 from the first end 142 to the second end 144 (e.g., between the sidewalls 146 in a bottom of the housing 140). The first and second brackets 130a, 130b also may be configured to support (e.g., fixedly support) the housing 140. For example, the first and second brackets 130a, 130b may also include couplings, such as holes, recesses, detents, projections, and/or other physical constructions that facilitate coupling the first and second brackets 130a, 130b to the housing 140, either directly or indirectly. The first bracket 130a may be coupled to the first end 142 of the housing 140 and the second bracket 130b may be coupled to the second end 144 of the housing 140. The first and second brackets 130a, 130b may comprise walls 136 that line up with the sidewalls 146 of the housing 140. The housing 140 may be coupled to the first and second brackets 130a, 130b via fasteners 147 (e.g., screws) received in openings 138 in the first and second brackets 130a, 130b and openings 148 in the sidewalls 146 of the housing 140.

As shown in FIG. 8A, the head rail assembly 120 may further comprise a top cover 126 configured to cover a top of the head rail assembly 120 and a bottom cover 128 configured to cover a bottom of the head rail assembly 120. The top cover 126 may extend the length of the head rail assembly 120 (e.g., the length of the roller tube 122) between the first and second mounting brackets 130a, 130b. The bottom cover 128 may extend the length of the head rail assembly 120 (e.g., the length of the housing 140) and may cover the elongated slot 145 in the housing 140. The top cover 126 and the bottom cover 128 may be configured to attached to the head rail assembly 120 (e.g., to the first and second mounting brackets 130a, 130b) via one or more attachment mechanisms, such as snaps and/or fasteners (e.g., screws).

The housing 140 may house a battery holder 150 that may define a battery compartment 152 that may be sized and configured to receive the one or more batteries 154 for powering the motor drive unit 160. For example, the housing 140 may define an internal compartment 149 that is sized and configured to receive the battery holder 150. The battery holder 150 may comprise a cable 156 (e.g., electrical wiring) with a plug 155 at its end. The cable 156 may be electrically connected to the batteries 154 in the battery holder 150. The plug 155 may be configured to be electrically and mechanically connected to the connector 166 of the motor drive unit 160 for powering the motor drive unit 160. The cable 156 may extend from the battery holder 150 to the motor drive unit 160 adjacent to the first bracket 130a. The battery holder 150 may comprise a spring (not shown) for pushing the batteries 154 together and holding the batteries 154 in the battery compartment 152 of the battery holder 150 when the Roman shade system 100 is installed. The number and type of the batteries 154 that may be received in the battery compartment 152 of the battery holder 150 may be based on the type of window treatment system that will be supported. In some examples, the battery compartment 152 of the battery holder 150 may be sized and configured to receive five D-cell batteries, although one of ordinary skill in the art will understand that a different number and type (e.g., size and/or capacity) of batteries may be used depending on the power needs for a particular system. For example, while five D-cell batteries are referenced, one of ordinary skill in the art will understand that fewer (e.g., 1-4) or more batteries may be used. Additionally or alternatively, other types of batteries (e.g., A, AA, AAA, and/or lithium-ion batteries) may be used instead of D-cell batteries. In some examples, the motor drive unit 160 may be powered from an external power source, such as an alternating-current (AC) power source and/or a direct-current (DC) power supply, and/or from an energy-harvesting power source, such as a photovoltaic cell (e.g., a solar cell).

As shown in FIG. 8A, the battery holder 150 may be disposed at or adjacent to the first end 142 of the housing 140. Locating the motor drive unit 160 in the first end 121 of the roller tube 122 and the battery holder 150 adjacent to the first end 142 of the housing 140 may enable the plug 155 of the battery holder 150 to be electrically connected to the connector 166 of the motor drive unit 160 and may allow the cable 156 to be made as short as possible. In addition, the internal compartment 149 of the housing 140 in which the battery holder 150 is housed may be located below the roller tube 122, which may allow for easy access to the batteries 154 in the battery holder 150 when the Roller shade system 100 is installed to the structure. For example, the battery holder 150 may comprise a gap 158 (e.g., as shown in FIG. 11) through which the batteries 154 may be removed and replaced to allow for replacement of the batteries 154 through the elongated slot 145 in the housing 140. Since the batteries 154 may be received through the gap 158 in the battery holder 150 and the elongated slot 145 in the housing 140, the batteries 154 may be replaced without unmounting the head rail assembly 120 from the structure.

The head rail assembly 120 may also comprise a lift assistance subsystem 180, which may be housed and/or supported by the housing 140. For example, the internal compartment 149 of the housing 140 may also be sized and configured to receive and support the lift assistance subsystem 180, such that both the battery holder 150 and the lift assistance subsystem 180 may both be located in the internal compartment 149 of the housing 140. The lift assistance subsystem 180 may be configured to assist the motor drive unit 160 in the cavity 125 of the roller tube 122 with adjusting the shade fabric 102 between first and second positions (e.g., the raised and lowered positions or positions therebetween). In some examples, such as when the shade fabric 102 is a Roman shade fabric, the lift assistance subsystem 180 may include a lift assistance spring 182. The lift assistance spring 182 may comprise a spring member (not shown) contained within an enclosure 183. For example, the spring member of the lift assistance spring 182 may be a variable-force spring, such as a negative-gradient spring, which may have a negative-gradient force profile (e.g., decreasing load with increasing deflection). The negative-gradient spring of the lift assistance spring 182 may provide greater assistance (e.g., a greater force) when the shade fabric 102 is near the raised position (e.g., the fully-raised position) as compared to when the shade fabric 102 is near the lowered position (e.g., the fully-lowered position), e.g., as there is less torque required to move the roller tube 122 when the shade fabric 102 is near the lowered position (e.g., the fully-lowered position) compared to when the shade fabric 102 is near the raised position (e.g., the fully-raised position). For example, the lift assistance subsystem 180 may comprise a single lift assistance spring 182 as shown in FIG. 8A or multiple lift assistance springs 182 as shown in FIG. 8B.

The lift assistance subsystem 180 may comprise a shaft 184 that may be configured to rotate about a second axis 118 (FIG. 7). The shaft 184 may extend through a channel 185 (e.g., a keyed channel) in the enclosure 183 of the lift assistance spring 182. The channel 185 may extend all the way through the enclosure 183 of the lift assistance spring 182. The channel 185 may be keyed to engage with the shaft 184 (e.g., the channel 185 may have a cross-sectional area that substantially matches a cross-sectional area of the shaft 184). As the shaft 184 rotates about the second axis 118 in first and second angular directions, the spring member in the enclosure 183 of the lift assistance spring 182 may tighten and loosen, respectively. The channel 185 may be rotatable such that rotations of the shaft 184 (e.g., when received in the channel 185) may cause the channel 185 to rotate, which may cause the spring member of the lift assistance spring 182 to expand and contract. For example, the shaft 184 may have a varying length depending on the number of the lift assistance springs 182 in the lift assistance subsystem 180 (e.g., as shown in FIG. 8B where the shaft 184 is broken). In some examples, the lift assistance spring 182 may comprise as integral shaft that extends from the enclosure 183 and the shafts of adjacent lift assistance springs may be coupled together

The head rail assembly 120 may comprise a clamp 181 that may be received in the internal cavity 149 of the housing 140 (e.g., spanning the elongated slot 145 as shown in FIG. 10). The clamp 181 may tightened to be held in place in the internal cavity 149 of the housing 140 in a location at which the clamp 181 abuts against the lift assistance spring 182 of the lift assistance subsystem 180 (e.g., to hold the lift assistance spring 182 against the second bracket 130b). The location of the clamp 181 is adjustable depending on the number of lift assistance spring 182 in the lift assistance subsystem 180.

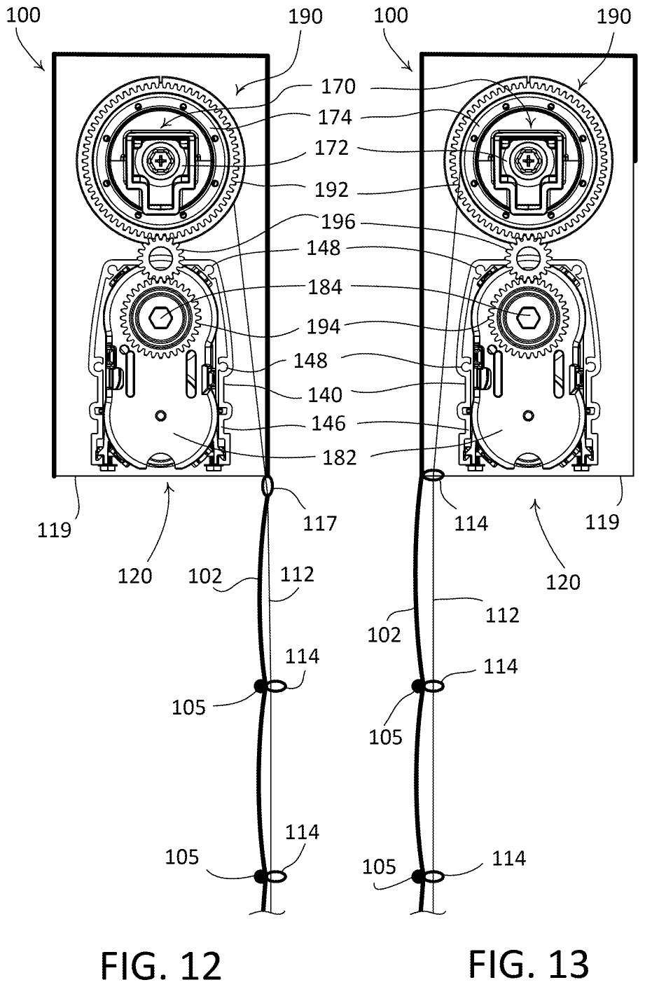

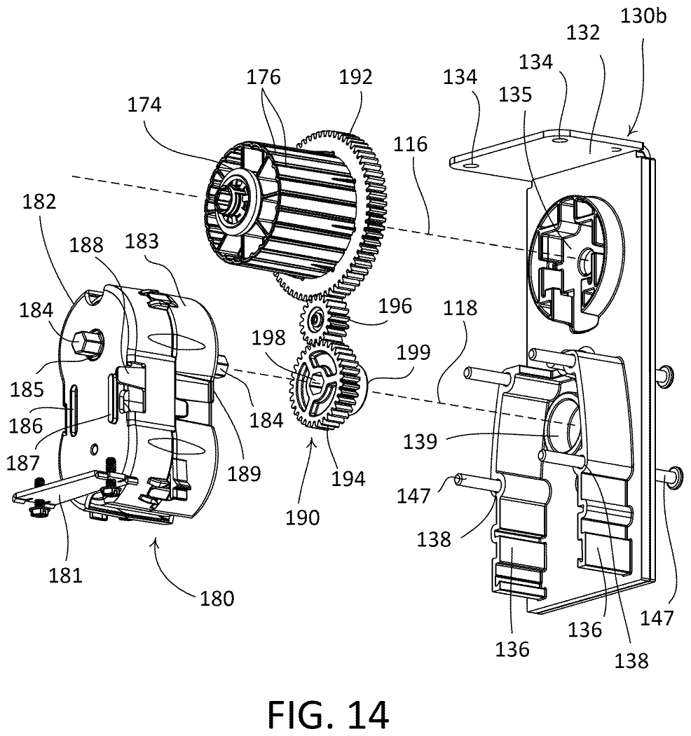

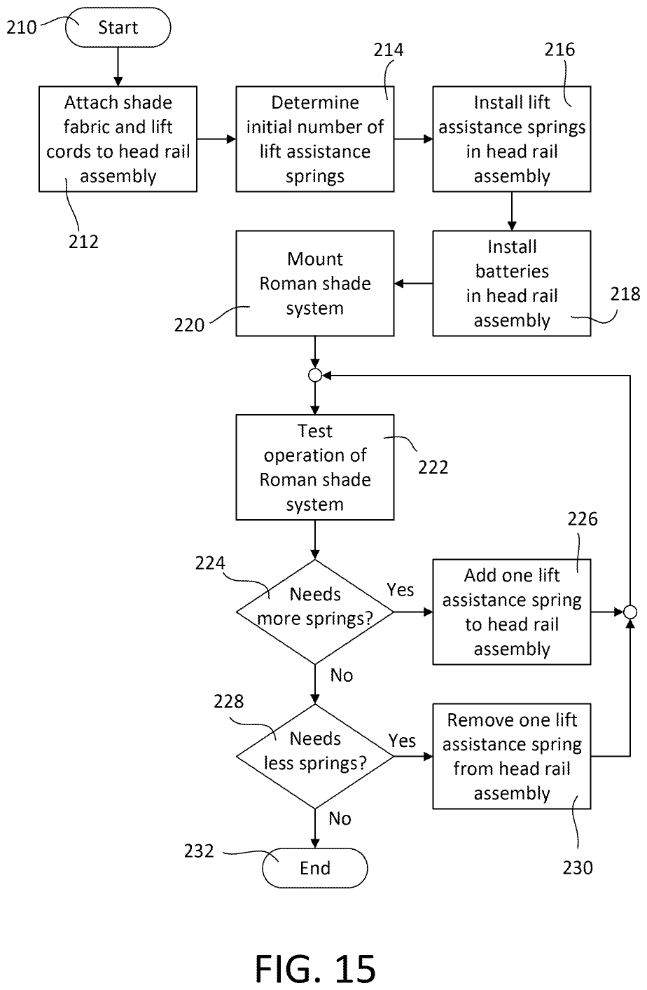

The roller tube 122 may be coupled to the shaft 184 of the lift assistance subsystem 180 via a gear assembly 190. FIGS. 12-13 are right side views of the Roman shade system 100 (e.g., with the right-side bracket 130b of the head rail assembly 120 not shown in order to illustrate the gear assembly 190 in greater detail). FIG. 12 shows the Roman shade system 100 in a front-control configuration (e.g., a rear-fabric configuration) and FIG. 13 shows the Roman shade system 100 in a rear-control configuration (e.g., a front-fabric configuration). FIG. 14 is a partial exploded view of the head rail assembly 120 showing the second bracket 130b, the light assistance subsystem 180, and the gear assembly 190 in greater detail. The gear assembly 190 may be supported by the second bracket 130b and may be configured to mechanically couple the roller tube 122 to the lift assistance spring 182 of the lift assistance subsystem 180 (e.g., as will be described in greater detail below).

In the front-control configuration shown in FIG. 12, the head rail assembly 120 may be located towards the room in which the Roman shade system 100 is installed and the shade fabric 102 may be located towards the window that the Roman shade system 100 is adapted to cover (e.g., the window may be located to the right of the shade fabric 102 as shown in FIG. 12). The cords 112 may extend from the roller tube 122 through an opening 115 in the shade fabric 102 towards the lowest one of the battens 105 between the shade fabric 102 and the window. In the front-control configuration, the shade fabric 102 may hang from the window-side of the enclosure 119 and may wrap around the enclosure 119 as shown in FIG. 12 to provide an aesthetically pleasing appearance for the enclosure 119.

In the rear-control configuration shown in FIG. 13, the head rail assembly 120 may be located towards the window that the Roman shade system 100 is adapted to cover and the shade fabric 102 may be located towards the room in which the Roman shade system 100 is installed (e.g., the window may be located to the right of the shade fabric 102 as shown in FIG. 13). The cords 112 may extend from the roller tube 122 towards the lowest one of the battens 105 between the shade fabric 102 and the window. In the rear-control configuration, the shade fabric 102 may hang from the room-side of the enclosure 119 and may wrap at least partially around the enclosure 119 as shown in FIG. 13 to provide an aesthetically pleasing appearance for the enclosure 119.

The gear assembly 190 may comprise a first gear 192 that may be coupled (e.g., fixedly coupled) to the roller tube 210 (e.g., to the second end 214 of the roller tube 122) and may be configured to rotate about the first axis 116. For example, the idler assembly 170 may comprise a stationary portion 172 (FIGS. 12 and 13) configured to be attached to (e.g., fixedly attached to) the attachment structure 135 (FIG. 14) of the second bracket 130b. The idler assembly 170 may also comprise a rotatable portion 174 configured to be received in the second end 123 of the roller tube 122 and attached to (e.g., fixedly attached to) the roller tube 122. For example, the rotatable portion 174 may comprise notches 176 configured to receive ribs (not shown) on an inner surface of the roller tube for fixedly attaching the rotatable portion 174 to the roller tube 122. The rotatable portion 174 may be configured to rotate around the stationary portion 172, e.g., as the motor drive unit 160 rotates the roller tube 122. For example, the stationary portion 172 and the rotatable portion 174 may meet at a bearing surface (not shown). The first gear 192 may be connected to (e.g., formed as a part of) the rotatable portion 174 of the idler assembly 170, such that the first gear 192 rotates as the roller tube 122 rotates.

The gear assembly 190 may also comprise a second gear 194 that may be coupled (e.g., fixedly coupled) to the shaft 184 of the lift assistance subsystem 180 and may be configured to rotate about the second axis 118. The second gear 194 may comprise an opening 198 configured to receive and attach to the shaft 184 of the lift assistance subsystem 180. The second gear 194 may also comprise a drum 199 (e.g., a cylindrical drum) configured to be received (e.g., rotatably received) within an opening 139 (e.g., a cylindrical opening) in the second bracket 130b. The gear assembly 190 may comprise a third gear 196 located between the first and second gears 192, 194, and configured to mechanically couple the first gear 192 to the second gear 194. The second bracket 130b may support the first, second, and third gears 192, 194, 196 of the gear assembly 190. The engagement between the first, second, and third gears 192, 194, 196 of the gear assembly 190 may provide the connection through which the lift assistance subsystem 180 provides the assistance to the motor of the motor drive unit 160 in moving the shade fabric 102.

In operation, the motor of the motor drive unit 160 may cause the roller tube 122 to rotate in either a first angular direction (e.g., clockwise) or a second angular direction (e.g., counterclockwise) depending on whether the shade fabric 102 is to be moved toward the lowered position or toward the raised position. As the roller tube 122 rotates, the cords 112, for example, may be either wound around the roller tube 122 (e.g., guided by the lift rings 110) or unwound from the roller tube 122 depending on the direction of the rotation. When the cords 112 are wound around the roller tube 122, the cords 112 may pull on the battens 105 to cause the shade fabric 102 to raise and fold. For example, if starting in the lowered position, rotation of the roller tube 122 may cause the cords 112 to wind around the roller tube 122, which may result in the lowest one of the battens 105 (e.g., along with the shade fabric 102) being pulled in an upward direction. When the lowest one of the battens 105 contacts the next highest batten, both the lowest one of the battens 105 and the next highest one of the battens 105 may move together in an upward direction. When lowering of the shade fabric 102, all of the battens 105 may move together until a pleat is fully expanded at which point the upper-most batten may stop moving (e.g., due to its engagement with the shade fabric 102) and the remainder of the lower battens 105 may continue to move in a downward direction until all of the battens 105 reach their lowest position.

Since the shade fabric 122 may vary in size, material, and/or style from one installation of the Roller shade system 100 to the next (e.g., and thus vary in weight from one installation to the next), the lift assistance subsystem 180 may be re-configurable such that the motor drive unit 160 may be assembled to raise and lower shade fabrics of a particular weight. For example, the lift assistance subsystem 180 of the head rail assembly 120 may be configured to include multiple lift assistance springs (e.g., each of which may be the same as the lift assistance spring 182) as shown in FIG. 8B. The number of lift assistance springs 182 installed in the head rail assembly 120 may depend on the weight of the shade fabric 102. For example, when the lift assistance subsystem 180 includes multiple lift assistance springs 182, the shaft 184 of the lift assistance subsystem 180 may extend through respective openings 185 in the multiple lift assistance springs 182 and thus engage with the multiple lift assistance springs 182 as the shaft 184 rotates (e.g., to provide additional assistance to the motor drive unit 160). The internal cavity 149 of the housing 140 may be sized and configured to receive and support multiple lift assistance springs 182.

When the lift assistance subsystem 180 includes multiple lift assistance springs 182, the lift assistance springs 182 may be lined up together along the shaft 184, such that the lift assistance springs 182 make contact with each other. As shown in FIG. 14, the enclosure 183 of each lift assistance spring 182 may comprise a group (e.g., a pair) of alignment members, e.g., a protrusion 186 and a recess 187, on each side of the enclosure 183 of the lift assistance spring 182. While only one group (e.g., pair) of alignment members can be seen in FIG. 14, the lift assistance spring 182 may comprise a second pair of alignment members on the opposite side of the enclosure 183. In addition, each group of alignment members may have more or less than a pair (e.g., more or less than two) alignment members. When two of the lift assistance springs 182 are lined up together along the shaft 184, the protrusion 186 on a first one of the lift assistance springs 182 may be received in the recess 187 on a second one of the lift assistance springs 182, and the protrusion 186 on the second one of the lift assistance springs 182 may be received in the recess 187 on the first one of the lift assistance springs 182. In addition, the enclosure 183 of each one of the lift assistance springs 182 may comprise a snap 188 configured to couple to a ledge 189 on an adjacent one of the lift assistance springs 182. In this way, the lift assistance springs 182 may be securely connected and aligned, and the lift assistance springs 182 may be installed in the head rail assembly 120 as a unit.

When there are too many or two few of the lift assistance springs 182 in the lift assistance subsystem 180, the Roller shade system 100 may not be spring-balanced correctly. When the Roller shade system 100 is not spring-balanced correctly, the load on the motor drive unit 160 may be increased when raising or lowering the shade fabric 102. This may increase a magnitude of a battery current drawn from the batteries 154 and thus power consumed by the motor drive unit 160 (e.g., power consumed from the batteries 154), which may lead to a shorter lifetime of the batteries 154. After the shade fabric 102 is installed on the head rail assembly 120, the motor drive unit 160 may be configured to execute a test procedure (e.g., a spring-balance verification procedure) to confirm that a proper number of the lift assistance springs 182 (e.g., a number of lift assistance springs 182 that achieves an optimized amount of power consumed from the batteries 154) are installed and/or to determine if the lift assistance subsystem 180 needs more or less lift assistance springs 182.

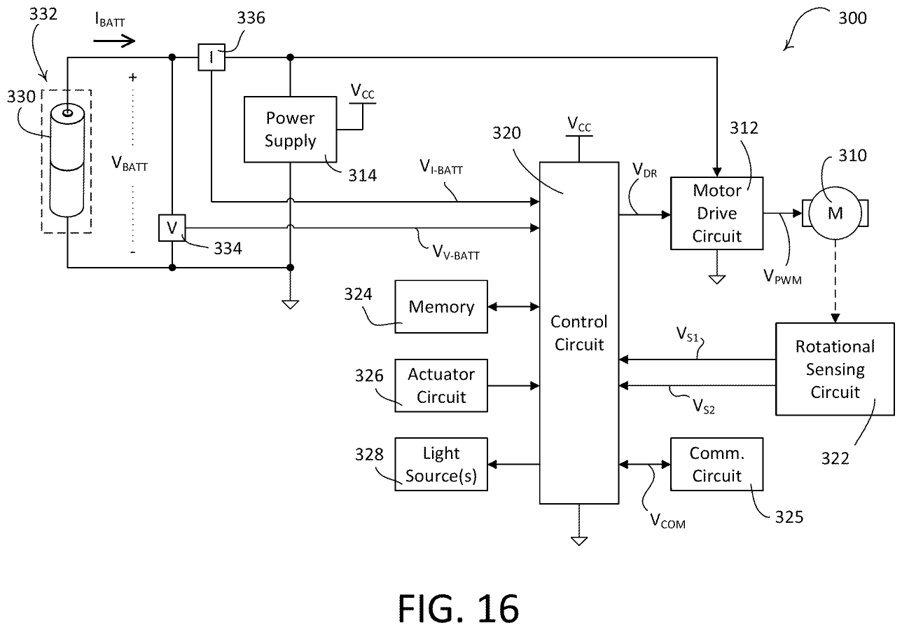

FIG. 15 is a flowchart of an example fabrication procedure 200 for building and/or configuring a window treatment system (e.g., such as the Roman shade system 100 shown in FIGS. 1-3). The fabrication procedure 200 may be performed by a technician (e.g., a manufacturing technician). The fabrication procedure 200 may be performed at a manufacturing facility, at the installation site of the window treatment system, and/or at another location. The fabrication procedure 200 may start at 210. At 212, the technician, for example, may install a covering material (e.g., the shade fabric 102) to a head rail assembly (e.g., the head rail assembly 120) of the window treatment system. For example, the covering material may be of a fabric type and size as specified by a customer. In addition, the technician may install one or more cords (e.g., the cords 112) and/or ribbons (e.g., ribbons 111) onto a roller tube of the head rail assembly (e.g., the roller tube 122) at 212.

At 214, the technician may determine a number (e.g., an initial number) of lift assistance springs (e.g., the lift assistance springs 182) to install in the head rail assembly. For example, the technician may determine the initial number of lift assistance springs based on the size, material, style, and/or weight of the covering material. The technician may refer to a reference guide (e.g., a table) that may identify the initial number of lift assistance springs based on the size, material, style, and/or weight of the covering material. In addition, the technician may use a program running on a computing device (e.g., computer, laptop, tablet, smart phone, etc.), which may identify the initial number of lift assistance springs after the size, material, style, and/or weight of the covering material are entered into the program. At 216, the technician may install the initial number of lift assistance springs in the head rail assembly. For example, the technician may connect enclosures of the lift assistance springs together and insert the lift assistance springs into an internal cavity of a housing of the head rail assembly (e.g., the internal cavity 149 of the housing 140), such that a shaft (e.g., the shaft 184) is received through channels of the lift assistance springs. In addition, the technician may install a bracket (e.g., the second bracket 130b) on an end of the housing and position a clamp (e.g., the clamp 181) within the internal cavity of the housing to hold the lift assistance springs against the bracket at 216. At 218, the technician may install one or more batteries (e.g., the batteries 154) in a battery holder (e.g., the battery holder 150), insert the battery holder in the internal cavity of the housing, and install a bracket (e.g., the first bracket 130a) on another end of the housing.

At 220, the technician may mount the head rail assembly to a test installation structure, which may allow a motor drive unit (e.g., the motor drive unit 160) of the window treatment system to raise (e.g., fully raise) and lower (e.g., fully lower) the covering material. At 222, the technician may cause the motor drive unit of the window treatment system to execute a test procedure (e.g., a spring-balancing verification procedure). For example, the technician may actuate a button on the motor drive unit to cause the motor drive unit to execute the test procedure. In addition, the motor drive unit may be configured to execute the text procedure in response to receiving a message from an external device. For example, the technician may associate (e.g., pair) a remote control device (e.g., a wireless remote control device) with the motor drive unit and actuate a button on the remote control device to cause the remote control device to transmit a message to the motor drive unit (e.g., via one or more wireless signals) for causing the motor drive unit to execute the test procedure. Additionally or alternatively, the technician may use a computing device (e.g., a smart phone or tablet) to transmit a message to the motor drive unit via a wired or wireless communication link For example, the computing device may be configured to transmit the message to the motor drive unit using a standard wireless communication protocol (e.g., such as the WI-FI protocol and/or the BLUETOOTH protocol) for causing the motor drive unit to execute the test procedure.

Once the test procedure has been started, the motor drive unit may be configured to rotate the roller tube to cause the window treatment system to move the covering material while monitoring an input power of the motor drive unit. For example, the motor drive unit may be configured to move the covering material through a raise movement, such as a full-raise movement (e.g., from a fully-lowered position to a fully-raised position) and a lower movement, such as a full-lower movement (e.g., from the fully-raised position to the fully-lowered position). The motor drive unit may be configured to monitor (e.g., periodically monitor) a magnitude of an input power P_{IN} of the motor drive unit (e.g., a power consumed from the batteries) while the motor drive unit is moving the covering material through the full-raise movement, for example, and/or while the motor drive unit is moving the covering material through the full-lower movement, for example. The motor drive unit may be configured to monitor the magnitude of the input power P_{IN} of the motor drive unit by determining (e.g., measuring) the input power P_{IN} once or periodically during the full-raise movement and/or the full-lower movement. The motor drive unit may be further configured to first position the covering material in the fully-raised position or the fully-lowered position prior to moving the covering material through the full-raise movement and/or through the full-lower movement, and determining (e.g., measuring) the input power P_{IN} during the respective movement.

In one example, the motor drive unit may be configured to determine a result of the test procedure by comparing the magnitude of the input power P_{IN} to one or more power thresholds (e.g., absolute power thresholds) while the motor drive unit is moving the covering material during the test procedure. For example, the motor drive unit may be configured to determine that the window treatment system requires at least one more lift assistance spring when the input power P_{IN} of the motor drive unit is greater than (e.g., greater than or equal to) a raise-movement power threshold P_{TH-RAISE} when the motor drive unit is raising the covering material during the full-raise movement. In addition, the motor drive unit may be configured to determine that the window treatment system requires at least one less lift assistance spring when the input power P_{IN} of the motor drive unit is greater than (e.g., greater than or equal to) a lower-movement power threshold P_{TH-LOWER} when the motor drive unit is lowering the covering material during the full-lower movement. The motor drive unit may be configured to determine that the window treatment system is appropriately spring-balanced when the magnitude of the input power P_{IN} of the motor drive unit is less than the raise-movement power threshold P_{TH-RAISE} when the motor drive unit is raising the covering material during the full-raise movement and/or the input power P_{IN} of the motor drive unit is less than the lower-movement power threshold P_{TH-LOWER} when the motor drive unit is lowering the covering material during the full-lower movement. For example, the raise-movement power threshold P_{TH-RAISE} may be equal to the lower-movement power threshold P_{TH-LOWER}. In some examples, the raise-movement power threshold P_{TH-RAISE} may be different than the lower-movement power threshold P_{TH-LOWER}. According to another example, rather than comparing the input power P_{IN} of the motor drive to the raise-movement power threshold P_{TH-RAISE} and/or the lower-movement power threshold P_{TH-LOWER} while the motor drive unit is moving (e.g., raising and/or lowering, respectively) the covering material, the motor drive unit may determine the input power P_{IN} of the motor drive unit one or more times during the full-raise movement and during the full-lower movement, determine a maximum value of the input power P_{IN} during each of the full-raise movement and the full-lower movement, and then compare these respective maximum values of the input power P_{IN} to the raise-movement power threshold P_{TH-RAISE} and the lower-movement power threshold P_{TH-LOWER}. Other variations are possible.

In another or additional example, the motor drive unit may be configured to determine a result of the test procedure by determining a maximum raising power P_{M-R} during a full-raise movement and a maximum lowering power P_{M-L} during a full-lower movement, and comparing a difference between the maximum raising power P_{M-R} and the maximum lowering power P_{M-L} to a relative power threshold P_{TH-R}. For example, the maximum raising power P_{M-R} may be a maximum value of the input power P_{IN} of the motor when the motor drive unit is raising the covering material during the full-raise movement, and the maximum lowering power P_{L-R} may be a maximum value of the input power P_{IN} of the motor when the motor drive unit is lowering the covering material during the full-lower movement. According to this example, after completing the full-raise movement and the full-lower movement, the motor drive unit may be configured to determine the difference between the maximum raising power P_{M-R} and the maximum lowering power P_{M-L} (e.g., by calculating an absolute value of a subtraction of the maximum lowering power P_{M-L} from the maximum raising power PM-R or an absolute value of a subtraction of the maximum raising power P_{M-R} from the maximum lowering power P_{M-L}). The motor drive unit may be configured to determine that the window treatment system requires more or less lift assistance springs when the difference between the maximum raising power P_{M-R} and the maximum lowering power P_{M-L} is greater than (e.g., greater than or equal to) the relative power threshold P_{TH-R}.

The motor drive unit may be configured to determine whether the window treatment system requires at least one less lift assistance spring or at least one more lift assistance spring by comparing the maximum raising power P_{M-R} and the maximum lowering power P_{M-L}. The motor drive unit may be configured to determine that the window treatment system requires at least one more lift assistance spring when the comparison between the maximum raising power P_{M-R} and the maximum lowering power P_{M-L} indicates that the maximum raising power P_{M-R} is greater than (e.g., greater than or equal to) the maximum lowering power P_{M-L}, and determine that the window treatment system requires at least one less lift assistance spring when the comparison between the maximum raising power P_{M-R} and the maximum lowering power P_{M-L} indicates that the maximum lowering power P_{M-L} is greater than (e.g., greater than or equal to) the maximum raising power P_{M-R}. The motor drive unit may be configured to determine that the window treatment system is appropriately spring-balanced when the difference between the maximum raising power P_{M-R} and the maximum lowering power P_{M-L} is less than the relative power threshold P_{TH-R}.

In examples (e.g., all examples of the test procedure), the motor drive unit may be configured to communicate an indication of the result of the test procedure (e.g., an indication that the window treatment system is appropriately spring-balanced or an indication that the window treatment system requires more or less lift assistance springs). Depending upon the results of the test procedure, the indication that the window treatment system requires more or less lift assistance springs may be an indication that the window treatment system requires more lift assistance springs or an indication that the window treatment system requires less lift assistance springs. For example, the indication of the result of the test procedure may be an indication that the magnitude of the input power P_{IN} was greater than (e.g., greater than or equal to) one of the raise-movement power threshold P_{TH-RAISE} or the lower-movement power threshold P_{TH-LOWER} while the motor drive unit was moving the covering material during the test procedure, or that the magnitude of the input power P_{IN} exceeded neither the raise-movement power threshold P_{TH-RAISE} nor the lower-movement power threshold P_{TH-LOWER} while the motor drive unit was moving the covering material during the test procedure. Additionally or alternatively, the indication of the result of the test procedure may be an indication that the difference between the maximum raising power P_{M-R} and the maximum lowering power P_{M-L} is greater than (e.g., greater than or equal to) than the relative power threshold P_{TH-R}. Further, the indication of the result of the test procedure may be an indication that the maximum raising power P_{M-R} is greater than (e.g., greater than or equal to) the maximum lowering power P_{M-L} or an indication that the maximum lowering power P_{M-L} is greater than (e.g., greater than or equal to) the maximum raising power P_{M-R}. Further, the indication of the result of the test procedure may be an indication to add more lift assistance springs, an indication to remove lift assistance springs, or that no further additions or removals of lift assistance springs is required, e.g., an indication that the window treatment system is appropriately spring-balanced.

The motor drive unit may be configured to communicate the indication of the result of the test procedure by illuminating one or more visible indicators (e.g., the visible indicator on the end portion 165 of the motor drive unit 160, such as a light-emitting diode) to provide the indication of the result of the test procedure. For example, the motor drive unit may be configured to blink the visible indicator(s) with a unique blink sequence (e.g., pattern) to indicate each of the different results of the test procedure (e.g., the window treatment system is appropriately spring-balanced, requires more lift assistance springs, or requires less lift assistance springs). The technician may view and interpret the unique blink sequence for determining the result of the test procedure. The motor drive unit may be configured to blink the visible indicator(s) with the unique blink sequence to indicate the result of the test procedure at the end of the test procedure (e.g., after the full-raise movement and/or the full-lower movement). For example, the motor drive unit may be configured to blink the visible indicator(s) with the unique blink sequence multiple times to ensure that the technician can view and interpret the unique blink sequence. In some examples, the motor drive unit may be configured to blink the visible indicator(s) with the unique blink sequence when the magnitude of the input power P_{IN} of the motor drive unit is greater than (e.g., is greater than or equal to) the raise-movement power threshold P_{TH-RAISE} during and/or after the full-raise movement and when the magnitude of the input power P_{IN} of the motor drive unit is greater than (e.g., is greater than or equal to) the lower-movement power threshold P_{TH-LOWER} during and/or after the full-lower movement. While the motor drive unit is described as having a single visible indicator, the motor drive unit may alternatively comprise more than one visible indicator and/or a more complex visible indicator, such as a visible display.

Additionally or alternatively, the motor drive unit may be configured to communicate the indication of the result of the test procedure by transmitting a message via signals (e.g., wireless signals, such as radio-frequency signals). For example, the motor drive unit may be configured to transmit a message including the indication of the result of the test procedure to a computing device used by the technician (e.g., a personal computer, laptop, tablet, smart phone, etc.). The computing device may be configured to display the indication of the result of the test procedure on a visible display of the computing device. For example, the motor drive unit may be configured to transmit the message including the indication of the result of the test procedure to the computing device at the end of the test procedure (e.g., after the full-raise movement and/or the full-lower movement).

After the motor drive unit communicates the indication of the result of the test procedure (e.g., the test procedure is complete), the technician may respond to the result of the test procedure. When the result of the test procedure is that the window treatment system needs more lift assistance springs at 224, the technician may add one lift assistance spring to the head rail assembly of the window treatment system at 226 and then may test the operation of the window treatment system again at 222. When the result of the test procedure is that the window treatment system does not need more lift assistance springs at 224, but needs less lift assistance springs at 228, the technician may remove one lift assistance spring from the head rail assembly of the window treatment system at 230 and then may test the operation of the window treatment system again at 222. When the result of the test procedure is that the window treatment system does not need more lift assistance springs at 224 and does not need less lift assistance springs at 228 (e.g., the window treatment system is appropriately spring-balanced), the fabrication procedure 200 may end at 232.

While the fabrication procedure 200 has been described with the motor drive unit providing a unique blink sequence (e.g., pattern) to indicate each of the different results of the test procedure (e.g., the window treatment system is appropriately spring-balanced, requires more lift assistance springs, or requires less lift assistance springs), in some examples the motor drive unit may not be configured to provide a unique blink sequence (e.g., have no response) when the window treatment system is appropriately spring-balanced, but may only provide a unique blink sequence when the window treatment system requires more lift assistance springs or requires less lift assistance springs. In addition, in some examples, the motor drive unit may be configured to provide a single blink sequence when the window treatment system is not appropriately spring-balanced (e.g., the motor drive unit may not provide a unique blink sequence when the window treatment system requires more lift assistance springs as compared to when the window treatment system requires less lift assistance springs). In such an example, the technician may determine if the single blink sequence is provided when the motor drive unit is moving through the full-raise movement or the full-lower movement to determine when the window treatment system requires more lift assistance springs or when the window treatment system requires less lift assistance springs, respectively.

In addition, while the fabrication procedure 200 has been described with the motor drive unit moving through the full-raise movement and the full-lower movement during the test procedure at 222, the fabrication procedure 200 may also be implemented with the motor drive unit only moving the covering material through one of the movements, for example, the full-raise movement. In this example, the technician may not need to determine the initial number of lift assistance springs to install in the head rail assembly at 214 (e.g., 214 may be omitted from the fabrication procedure 200), but may simply install a single lift assistance spring in the head rail assembly at 216. The motor drive unit may execute the test procedure and only move the covering material through the full-raise movement during the test procedure at 222. The motor drive unit may be configured to communicate an indication that the window treatment system requires more lift assistance springs during and/or after the full-raise movement. The technician may repeatedly execute the test procedure until the correct number of lift assistance springs are added to and/or installed in the head rail assembly. Further, the fabrication procedure 200 may be implemented with the technician initially installing the maximum number of lift assistance spring in the head rail assembly and only moving the covering material through the full-lower movement during the test procedure to determine whether less lift assistance springs are required.

While the fabrication procedure 200 has been described herein with the technician determining whether to install more or less lift assistance springs of the same type in the window treatment system, the fabrication procedure 200 may also be used to determine whether to install lift assistance springs of different forces and/or force gradients (e.g., lift assistance springs providing more or less force) to replace an existing lift assistance spring. For example, the technician may install a lift assistance spring that provides more force at 226 and/or a lift assistance spring that provides less force at 230. In addition, the fabrication procedure 200 may be used to determine whether to install lift assistance springs of different forces and/or force gradients on in a single window treatment system.

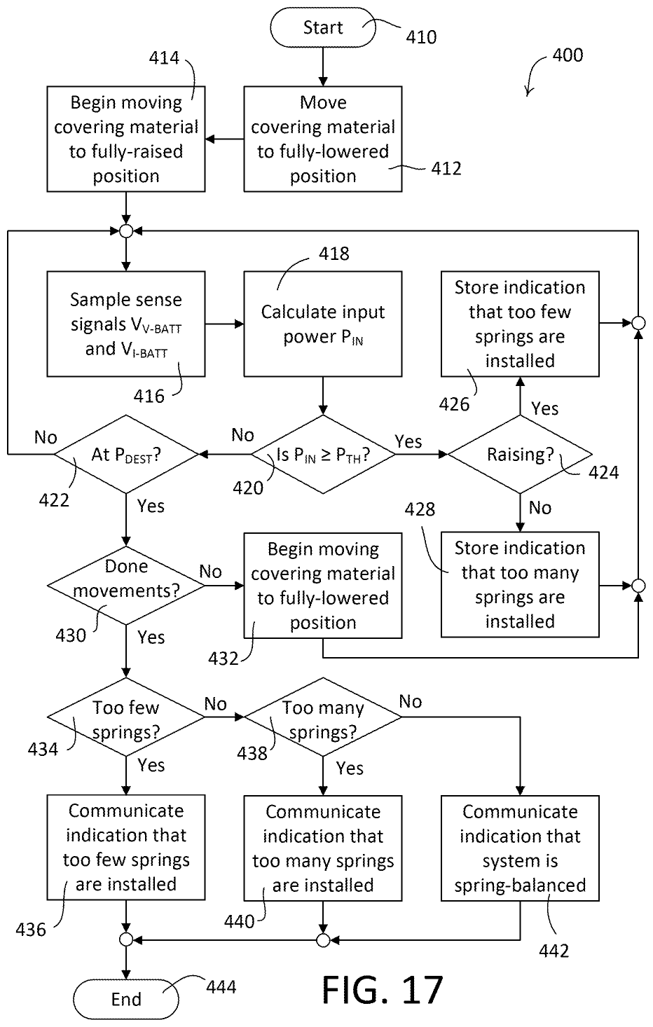

FIG. 16 is a block diagram of a motor drive unit 300 (e.g., the motor drive unit 160) of a window treatment system (e.g., the Roman shade system 100). The motor drive unit 300 may include a motor 310 (e.g., a direct-current motor) that may be coupled to a roller tube of the motorized window treatment (e.g., the roller tube 122) for rotating the roller tube. Rotation of the roller tube may be configured to raise and lower a covering material (e.g., the shade fabric 102). The motor drive unit 300 may comprise a compartment 332 (e.g., which may be an example of the battery holder 150 of the head rail assembly 120 shown in FIGS. 4-8) that is configured to receive a DC power source. The DC power source may be, for example, one or more batteries 330. In this example, the compartment 332 may be configured to receive one or more batteries 330 (e.g., four “D” batteries), such as the batteries 154 of FIGS. 4-8. The batteries 330 may provide a battery voltage V_{BATT} to the motor drive unit 300. In addition, alternate DC power sources, such as a solar cell (e.g., a photovoltaic cell), an ultrasonic energy source, and/or a radio-frequency (RF) energy source, may be coupled in parallel with the one or more batteries 330, or in some examples be used as an alternative to the batteries 330. Further, an external DC power supply may be configured to be coupled in parallel with the one or more batteries 330. The alternate DC power source and/or the external DC power supply may be used to perform the same and/or similar functions as the one or more batteries 330.

The motor drive unit 300 may include a motor drive circuit 312 (e.g., an H-bridge drive circuit) that receives the battery voltage V_{BATT} and may generate a pulse-width modulated (PWM) voltage V_{PWM} for driving the motor 310. While not shown in FIG. 16, the motor drive unit 300 may comprise a power converter circuit (e.g., a boost converter circuit) coupled between the batteries 330 and the motor drive circuit 312 for receiving the battery voltage V_{BATT} and generating a boosted voltage that may be received by the motor drive circuit 312 for driving the motor 312. The motor drive unit 300 may also include a power supply 314 that may receive the battery voltage V_{BATT} and generate a supply voltage V_{CC} for powering the low-voltage circuitry of the motor drive unit 300.

The motor drive unit 300 may include a control circuit 320 for controlling the operation of the motor 310. The control circuit 320 may include, for example, a microprocessor, a programmable logic device (PLD), a microcontroller, an application specific integrated circuit (ASIC), a field-programmable gate array (FPGA), or any suitable processing device or control circuit. The control circuit 320 may be configured to generate one or more drive signals V_{DR} for controlling the motor drive circuit 312. The one or more drive signals V_{DR} may be configured to control a rotational speed and/or a direction of rotation of the motor 310. For example, as shown in FIG. 16, the motor drive circuit 312 and the control circuit 320 may conduct a battery current I_{BATT} from the batteries 330. The control circuit 320 may be configured to control the motor drive circuit 312 to rotate the motor 310 to adjust a present position P_{PRES} of the covering material between a fully-raised position P_{RAISED} and a fully-lowered position P_{LOWERED}.

The motor drive unit 300 may include a rotational position sensing circuit 322, such as, for example, a Hall effect sensor (HES) circuit, which may be configured to generate first and second rotational position sensing signals V_{S1}, V_{S2}. The first and second rotational position sensing signals V_{S1}, V_{S2} may indicate the rotational speed and/or the direction of the motor 310 to the control circuit 320. The rotational position sensing circuit 322 may include other suitable position sensors, such as, for example, magnetic, optical, and/or resistive sensors. The control circuit 320 may be configured to determine the rotational position of the motor 310 in response to the first and second rotational position sensing signals V_{S1}, V_{S2} generated by the rotational position sensing circuit 322. The control circuit 320 may be configured to determine a present position of the covering material in response to the rotational position of the motor 310. The operation of a motor drive circuit and a rotational position sensing circuit of an example motor drive unit is described in greater detail in commonly-assigned U.S. Pat. No. 5,848,634, issued Dec. 15, 1998, entitled MOTORIZED WINDOW SHADE SYSTEM, and commonly-assigned U.S. Pat. No. 7,839,109, issued Nov. 23, 2010, entitled METHOD OF CONTROLLING A MOTORIZED WINDOW TREATMENT, the entire disclosures of which are hereby incorporated by reference.

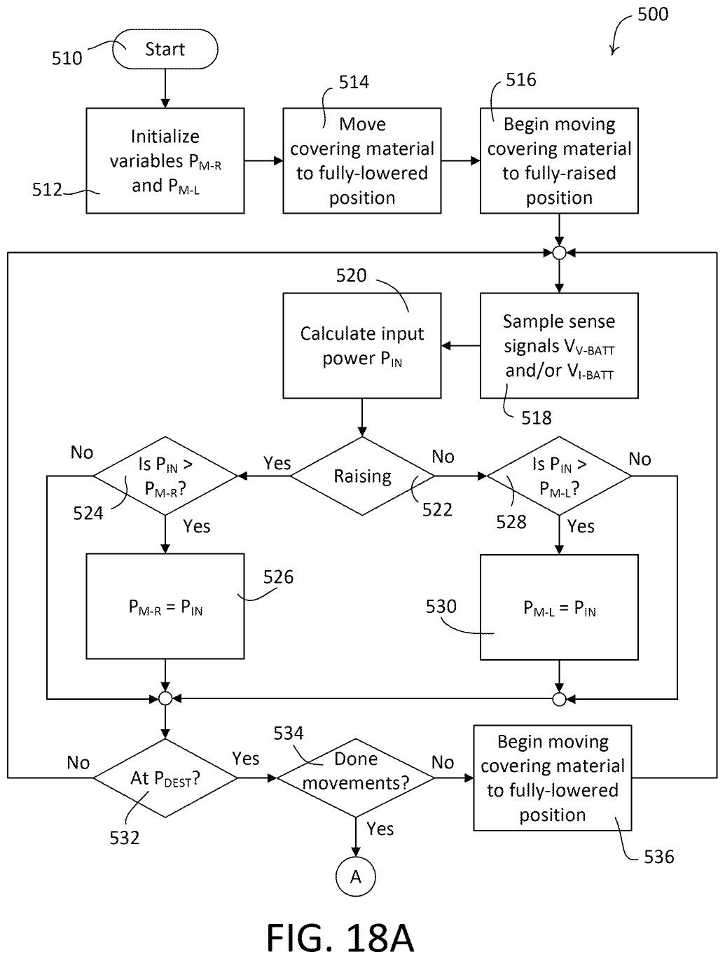

The motor drive unit 300 may comprise a memory 324 configured to store operational characteristics, e.g., such as the present position of the covering material and/or limits for controlling the position of the covering material (e.g., the raised position P_{RAISED} and/or the lowered position P_{LOWERED}). The memory 324 may be implemented as an external integrated circuit (IC) or as an internal circuit of the control circuit 320. The memory 324 may comprise a computer-readable storage media or machine-readable storage media that maintains computer-executable instructions for performing one or more procedure and/or functions as described herein. For example, the memory 324 may comprise computer-executable instructions or machine-readable instructions that when executed by the control circuit configure the control circuit to provide one or more portions of the procedures described herein (e.g., such as a test procedure 400 shown in FIG. 17). The control circuit 320 may access the instructions from memory 324 for being executed to cause the control circuit 320 to operate as described herein, or to operate one or more other devices as described herein. The memory 324 may comprise computer-executable instructions for executing configuration software. For example, the operational characteristics and/or the association information stored in the memory 324 may be configured during a configuration procedure of the sensor device 300.

The motor drive unit 300 may include a communication circuit 325 that may allow the control circuit 320 to transmit and receive messages (e.g., digital messages) via signals, e.g., wired signals and/or wireless signals, such as radio-frequency (RF) signals. The control circuit 320 may be configured to control the motor 310 to control the movement of the covering material in response to a shade movement command received in a message received via the communication circuit 325 from a remote control device. During a configuration procedure (e.g., an association procedure), the motor drive unit 300 may be associated with the remote control device, such that the motor drive unit 300 may be responsive to the messages transmitted by the remote control device (e.g., via wireless signals).

The motor drive unit 300 may comprise an actuator circuit 326 configured to receive user inputs. The actuator circuit 326 may comprise one or more switching devices, such as mechanical tactile switches that are configured to be actuated in response to actuations of one or more respective buttons on the motor drive unit 300 (e.g., the button on the end portion 165 of the motor drive unit 160). The control circuit 320 may be responsive to actuations of the switching devices of the actuator circuit 326. For example, the control circuit 320 may be configured to enter the configuration procedure (e.g., for being associated with the remote control device) in response to an actuation of one of the buttons of the motor drive unit 300.

The motor drive unit 300 may include one or more light sources 328 that may be configured to illuminate one or more respective visible indicators of the motor drive unit 300 (e.g., such as the visible indicator on the end portion 165 of the motor drive unit 160). The control circuit 320 may be configured to control the one or more light sources 328 to illuminate the respective visible indicators to provide feedback to the user of the motorized window treatment. For example, the control circuit 320 may be configured to control the one or more light sources 328 to illuminate the respective visible indicators to provide feedback to the user during the configuration mode to indicate that the motor drive unit 300 is in the configuration mode. For example, the one or more light sources 228 may comprise one or more light-emitting diodes (LEDs).

The motor drive unit 300 may comprise a battery-voltage sense circuit 334 that may be electrically coupled in parallel with the batteries 330 for receiving the battery voltage V_{BATT} and generating a battery-voltage sense signal V_{V-BATT} that may indicate the magnitude of the battery voltage V_{BATT}. For example, the battery-voltage sense circuit 334 may comprise a resistive divider circuit having two resistors coupled in series, with the series combination of the resistor coupled in parallel with the batteries 330. The battery-voltage sense signal V_{V-BATT} may be generated at the junction of the resistors, such that a magnitude of the battery-voltage sense signal V_{V-BATT} is proportional to the magnitude of the battery voltage V_{BATT}.

The motor drive unit 300 may comprise a battery-current sense circuit 336 that may be electrically coupled in series between the batteries 330 and the motor drive circuit 312 for conducting the battery current I_{BATT} and generating a battery-current sense signal V_{I-BATT} that may indicate the magnitude of the battery current I_{BATT}. For example, the battery-current sense circuit 336 may comprise a sense resistor circuit coupled in series between the batteries 330 and the motor drive circuit 312 (e.g., for conducting the battery current I_{BATT}). The battery-current sense signal V_{I-BATT} may be generated at across the sense resistor, such that a magnitude of the battery-current sense signal V_{I-BATT} is proportional to the magnitude of the battery current I_{BATT}.

The control circuit 320 may receive the battery-voltage sense signal V_{V-BATT} from the battery-voltage sense circuit 334 and the battery-current sense signal V_{I-BATT} from the battery-current sense circuit 336. For example, the control circuit 320 may comprise one or more analog-to-digital converters (ADCs) for sampling the battery-voltage sense signal V_{V-BATT} and the battery-current sense signal V_{I-BATT}. The control circuit 320 may be configured to monitor a magnitude of an input power P_{IN} of the motor drive unit 300 (e.g., a power consumed from the batteries 330). The control circuit 320 may be configured to determine the magnitude of the input power P_{IN} of the motor drive unit 300 based on the magnitude of the battery-voltage sense signal V_{V-BATT} and the magnitude of the battery-current sense signal V_{I-BATT}. For example, the control circuit 320 may be configured to calculate the magnitude of the input power P_{IN} by multiplying the magnitude of the battery voltage V_{BATT} (e.g., as indicated by the magnitude of the battery-voltage sense signal V_{V-BATT}) by the magnitude of the battery current I_{BATT} (e.g., as indicated by the magnitude of the battery-current sense signal V_{I-BATT}). In some examples, the control circuit 320 may be configured to determine the magnitude of the input power P_{IN} of the motor drive unit 300 (e.g., a power consumed from the batteries) based on (e.g., based on only) the battery-current sense signal V_{I-BATT} (e.g., the motor drive unit 300 may not comprise the battery-voltage sense circuit 334). For example, the control circuit 320 may assume that the magnitude of the battery voltage V_{BATT} is a predetermined constant value, and calculate the magnitude of the input power P_{IN} by multiplying the predetermined constant value of the battery voltage V_{BATT} by the magnitude of the battery current I_{BATT} (e.g., as indicated by the magnitude of the battery-current sense signal V_{I-BATT}).

The lifetime of the batteries 330 may be dependent on the input power P_{IN} of the motor drive unit 300 (e.g., the power consumed from the batteries 330) during each movement of the covering material. The control circuit 320 may be configured to monitor the magnitude of the input power P_{IN} while controlling the motor drive circuit 312 to rotate the motor 310 to adjust the present position P_{PRES} of the covering material between the fully-raised position P_{RAISED} and the fully-lowered position P_{LOWERED}. The control circuit 320 may be configured to determine that the magnitude of the input power P_{IN} of the motor drive unit 300 (e.g., the power consumed from the batteries 330) is too large when the magnitude of the input power P_{IN} is greater than (e.g., is greater than or equal to) one or more power thresholds. The magnitude of the input power P_{IN} of the motor drive unit 300 may be too large when the window treatment system is not spring-balanced appropriately.

The control circuit 320 may be configured to execute a test procedure (e.g., the test procedure executed at 222 of the fabrication procedure 200) to determine if the window treatment system is spring-balanced correctly. The control circuit 320 may be configured to execute the test procedure in response to an actuation of one of the buttons of the motor drive unit 300 detected by the actuator circuit 326. In addition, the control circuit 320 may be configured to execute the test procedure in response to receiving a message via the communication circuit 325. During the test procedure, the control circuit 320 may be configured to control the motor drive circuit 312 to rotate the motor 310 to adjust the present position P_{PRES} of the covering material between the fully-raised position P_{RAISED} and the fully-lowered position P_{LOWERED}. For example, the control circuit 320 may be configured to adjust the present position P_{PRES} of the covering material through a raise movement, such as a full-raise movement (e.g., from the fully-lowered position P_{LOWERED} to the fully-raised position P_{RAISED}) and a lower movement, such as a full-lower movement (e.g., from the fully-raised position P_{RAISED} to the fully-lowered position P_{LOWERED}). The control circuit 320 may be configured to monitor the magnitude of the input power P_{IN} of the motor drive unit 300 while adjusting the present position P_{PRES} of the covering material through the full-raise movement and the full-lower movement.

In one example, the control circuit 320 may be configured to determine a result of the test procedure by comparing the magnitude of the input power P_{IN} to the one or more power thresholds while the control circuit 320 is controlling the motor drive circuit 312 to adjust the present position P_{PRES} of the covering material during the test procedure. The control circuit 320 may be configured to determine that the window treatment system requires at least one more lift assistance spring when the input power P_{IN} of the motor drive unit 300 is greater than (e.g., greater than or equal to) a raise-movement power threshold P_{TH-RAISE} when the control circuit 320 is controlling the motor drive circuit 312 to raise the covering material during the full-raise movement. The control circuit 320 may be configured to determine that the window treatment system requires at least one less lift assistance spring when the input power P_{IN} of the motor drive unit 300 is greater than (e.g., greater than or equal to) a lower-movement power threshold P_{TH-LOWER} when the control circuit is controlling the motor drive circuit 312 to lower the covering material during the full-lower movement. The control circuit 320 may be configured to determine that the window treatment system is appropriately spring-balanced when the magnitude of the input power P_{IN} of the motor drive unit 300 is less than the raise-movement power threshold P_{TH-RAISE} when the control circuit is controlling the motor drive circuit 312 to raise the covering material during the full-raise movement or the input power P_{IN} of the motor drive unit 300 is less than the lower-movement power threshold P_{TH-LOWER} when the control circuit 312 is controlling the motor drive circuit 312 to lower the covering material during the full-lower movement. For example, the raise-movement power threshold P_{TH-RAISE} may be equal to the lower-movement power threshold P_{TH-LOWER}. According to another example, rather than comparing the input power P_{IN} of the motor drive to the raise-movement power threshold P_{TH-RAISE} and/or the lower-movement power threshold P_{TH-LOWER} while the motor drive unit 300 is moving (e.g., raising and/or lowering, respectively) the covering material, the control circuit 320 may determine the input power P_{IN} of the motor drive unit 300 one or more times during the full-raise movement and during the full-lower movement, determine a maximum value of the input power P_{IN} during each of the full-raise movement and the full-lower movement, and then compare these respective maximum values of the input power P_{IN} to the raise-movement power threshold P_{TH-RAISED} and the lower-movement power threshold P_{TH-LOWER}. Other variations are possible.

In another or additional example, the control circuit 320 may be configured to determine a result of the test procedure by determining a maximum raising power P_{M-R} during a full-raise movement and a maximum lowering power P_{M-L} during a full-lower movement, and comparing a difference between the maximum raising power P_{M-R} and a maximum lowering power P_{M-L} to a relative power threshold P_{TH-R}. For example, the maximum raising power P_{M-R} may be a maximum value of the input power P_{IN} of the motor when the control circuit 320 is controlling the motor drive circuit 312 to raise the covering material during the full-raise movement, and the maximum lowering power P_{L-R} may be a maximum value of the input power P_{IN} of the motor when the control circuit 320 is controlling the motor drive circuit 312 to lower the covering material during the full-lower movement. According to this example, after completing the full-raise movement and the full-lower movement, the control circuit 320 may be configured to determine the difference between the maximum raising power P_{TH-R} and the maximum lowering power P_{M-L} (e.g., by calculating an absolute value of a subtraction of the maximum lowering power P_{M-L} from the maximum raising power P_{M-R} or an absolute value of a subtraction of the maximum raising power P_{M-R} from the maximum lowering power P_{M-L}). The control circuit 320 may be configured to compare the maximum raising power P_{M-R} and the maximum lowering power P_{M-L}. The control circuit 320 may be configured to determine that the window treatment system requires at least one more lift assistance spring when the comparison between the maximum raising power P_{M-R} and the maximum lowering power P_{M-L} indicates that the maximum raising power P_{M-R} is greater than (e.g., greater than or equal to) the maximum lowering power P_{M-L}, and determine that the window treatment system requires at least one less lift assistance spring when the comparison between the maximum raising power P_{M-R} and the maximum lowering power P_{M-L} indicates that the maximum lowering power P_{M-L} is greater than (e.g., greater than or equal to) the maximum raising power P_{M-R}. The control circuit 320 may be configured to determine that the window treatment system is appropriately spring-balanced when the difference between the maximum raising power P_{M-R} and the maximum lowering power P_{M-L} is less than the relative power threshold P_{TH-R}.

The control circuit 320 may be configured to communicate an indication of the result of the test procedure (e.g., an indication that the window treatment system is appropriately spring-balanced, the window treatment system requires more lift assistance springs, or the window treatment system requires less lift assistance springs). The control circuit 320 may be configured to communicate an indication of the result of the test procedure by illuminating the one or more light sources 328 to provide the indication of the result of the test procedure. For example, the control circuit 320 may be configured to blink the one or more light sources 328 with a unique blink sequence (e.g., pattern) to indicate each of the different results of the test procedure (e.g., the window treatment system is appropriately spring-balanced, requires more lift assistance springs, or requires less lift assistance springs). Additionally or alternatively, the control circuit 320 may be configured to communicate the indication of the result of the test procedure by transmitting a message (e.g., including the indication of the result of the test procedure) via the communication circuit 325. Further, the control circuit 320 may be configured to communicate the indication of the test procedure by stopping movement of the covering material of the window treatment system and/or wiggling the covering material (e.g., quickly raising and lowering the covering material between two positions).

FIG. 17 is a flowchart of an example test procedure 400 for verifying proper spring-balancing of a window treatment system (e.g., the Roman shade system 100 shown in FIGS. 1-3). The test procedure 400 may be executed by a control circuit (e.g., the control circuit 320) of a motor drive unit (e.g., the motor drive unit 160, 300). The motor drive unit may comprise a motor (e.g., the motor 310) configured to rotate a roller tube (e.g., the roller tube 122) of the window treatment system for adjusting a present position P_{PRES} of a covering material (e.g., the shade fabric 102) between a lowered position P_{LOWERED} (e.g., a fully-lowered position) and a raised position P_{RAISED} (e.g., a fully-raised position). The motor drive unit may be powered by one or more batteries (e.g., the batteries 154, 360). The window treatment system may comprise a lift assistance subsystem (e.g., the lift assistance subsystem 180) having one or more lift assistance springs (e.g., the lift assistance springs 182) for assisting the motor drive unit in raising and lowering the covering material. The test procedure 400 may be executed by the control circuit during a fabrication procedure (e.g., at 222 of the fabrication procedure 200) of the window treatment system. The test procedure 400 may be initiated by a technician (e.g., the technician carrying out the fabrication procedure 200). In addition, the test procedure 400 may be executed by the control circuit after installation of the window treatment system as the final installation site, and/or executed periodically as a maintenance process to determine if the spring-balancing of the window treatment system has changed over time.

The control circuit may start the test procedure 400 at 410 in response to receiving an input from the technician. For example, the control circuit may start the test procedure 400 at 410 in response to detecting an actuation of a button of the motor drive unit (e.g., the button on the end portion 165 of the motor drive unit 160 and/or the buttons that actuate the switching devices of the actuator circuit 326). Additionally or alternatively, the control circuit may start the test procedure 400 at 410 in response to receiving a message (e.g., in one or more wireless signals, such as radio-frequency signals) via a communication circuit (e.g., the communication circuit 325).

At 412, the control circuit may control a motor drive circuit (e.g., the motor drive circuit 312) to drive the motor to adjust the present position P_{PRES} of the covering material to the lowered position P_{LOWERED}. For example, the control circuit may be configured to automatically adjust the present position P_{PRES} of the covering material to the lowered position P_{LOWERED} after the test procedure 400 is started. In some examples, the technician may manually adjust the present position P_{PRES} of the covering material to the lowered position P_{LOWERED} prior to the start of the test procedure 400 (e.g., adjustment of the covering material at 412 may be omitted from the test procedure 400).

At 414, the control circuit may begin moving (e.g., automatically begin moving) the covering material to the raised position P_{RAISED} (e.g., to start a full-raise movement of the covering material). For example, the control circuit may set a destination position P_{DEST} equal to the raised position P_{RAISED} at 414. At 416, the control circuit may sample one or more sense signals of the motor drive unit during the movement, for example, using one or more analog-to-digital converters (ADCs). For example, the control circuit may sample a battery-current sense signal V_{I-BATT} that may indicate a magnitude of a battery current I_{BATT} conducted through the batteries to generate a battery-current sample S_{I-BATT} at 416. In addition, the control circuit may sample a battery-voltage sense signal V_{V-BATT} that may indicate a magnitude of a battery voltage V_{BATT} produced by the batteries to generate a battery-voltage sample S_{V-BATT} at 416.

At 418, the control circuit may determine a magnitude of an input power P_{IN} of the motor drive unit (e.g., a power consumed from the batteries) based on the battery-voltage sense signal V_{V-BATT} and the battery-current sense signal V_{I-BATT}. For example, the control circuit may be configured to calculate the magnitude of the input power P_{IN} by multiplying the battery-voltage sample S_{V-BATT} by the battery-current sense signal S_{I-BATT}, e.g., P_{IN}=(α·S_{V-BATT})·(β·S_{I-BATT}), where α and β are coefficients having values dependent upon the electrical circuitry used to generate the battery-voltage sense signal V_{V-BATT} and the battery-current sense signal V_{I-BATT}, respectively. In some examples, the control circuit may determine the magnitude of the input power P_{IN} of the motor drive unit (e.g., a power consumed from the batteries) based on (e.g., based on only) the battery-current sense signal V_{I-BATT} (e.g., not based on the battery-voltage sense signal V_{V-BATT}). For example, the control circuit may be configured such that the magnitude of the battery voltage V_{BATT} is a predetermined constant value, and may calculate the magnitude of the input power P_{IN} by multiplying the predetermined constant value of the battery voltage V_{BATT} by the battery-current sense signal S_{I-BATT}.

At 420, the control circuit may determine if the magnitude of the input power P_{IN} is greater than (e.g., greater than or equal to) a power threshold P_{TH} (e.g., an absolute power threshold) while the control circuit is moving the covering material (e.g., raising the covering material as started at 414). For example, the control circuit may set the power threshold P_{TH} equal to a raise-movement power threshold P_{TH-RAISE} when the control circuit is raising the covering material during the full-raise movement, and equal to a lower-movement power threshold P_{TH-LOWER} when the control circuit is lowering the covering material during the full-lower movement. The raise-movement power threshold P_{TH-RAISE} may be, for example, equal to the lower-movement power threshold P_{TH-LOWER}. In some examples, the control circuit may compare the magnitude of the battery current I_{BATT} (e.g., the battery-current sample S_{I-BATT}) to a current threshold (e.g., if the control circuit is not configured to receive the battery-voltage sense signal V_{V-BATT}).

When the magnitude of the input power P_{IN} is not greater than (e.g., is less than) the power threshold P_{TH} at 420, the control circuit may determine if the covering material is at the destination position P_{DEST} (e.g., as set at 414) at 422. For example, the control circuit may determine that the covering material is at the destination position P_{DEST} if the present position P_{PRES} of the covering material is equal to the destination position P_{DEST} at 422. When the covering material is not at the destination position P_{DEST} at 422, the control circuit may continue to sample the battery-voltage sense signal V_{V-BATT} and/or the battery-current sense signal V_{I-BATT} at 416 and calculate the input power P_{IN} of the motor drive unit at 418.

When the magnitude of the input power P_{IN} is greater than (e.g., greater than or equal to) the power threshold P_{TH} (e.g., the raise-movement power threshold P_{TH-RAISE}) at 420 and the control circuit is presently raising the covering material at 424, the control circuit may at 426 store in memory (e.g., the memory 324) an indication that the window treatment system requires more or less lift assistance springs (e.g., that the window treatment system is not spring-balanced). For example, the control circuit may store in memory at 426 an indication that too few lift assistance springs are installed in the window treatment system at 426. In addition, the control circuit may communicate an indication that too few lift assistance springs are installed at 426, e.g., which may be an indication that the magnitude of the input power P_{IN} was greater than (e.g., greater than or equal to) the power threshold P_{TH} during the test procedure 400. For example, the control circuit may illuminate a visible indicator (e.g., by illuminating the one or more light source 328) to blink the visible indicator with a unique blink sequence that indicates that too few lift assistance springs are installed. Additionally or alternatively, the control circuit may transmit a message including the indication that too few lift assistance springs are installed at 426 (e.g., via a communication circuit 325). After storing in memory the indication that too few lift assistance springs are installed at 426, the control circuit may again sample the battery-voltage sense signal V_{V-BATT} and/aor the battery-current sense signal V_{I-BATT} at 416 and calculate the input power P_{IN} of the motor drive unit at 418.

When the covering material is at the destination position P_{DEST} at 422, the control circuit may determine at 430 if the control circuit is done with movements for the test procedure 400 (e.g., if the control circuit has moved the covering material through both the full-raise movement and the full-lower movement during the test procedure 400). If the control circuit is not done with movements (e.g., if the control circuit has only moved the covering material through the full-raise movement) at 430, the control circuit may begin moving the covering material to the fully-lowered position P_{LOWERED} (e.g., to start a full-lower movement of the covering material) at 432. For example, the control circuit may set a destination position P_{DEST} equal to the fully-lowered position P_{LOWERED} at 432. During the full-lower movement, the control circuit may sample the battery-voltage sense signal V_{V-BATT} and/or the battery-current sense signal V_{I-BATT} at 416 and calculate the input power P_{IN} of the motor drive unit at 418.

When the magnitude of the input power P_{IN} is greater than (e.g., greater than or equal to) the power threshold P_{TH} at 420 and the control circuit is presently lowering the covering material at 424, the control circuit may store in memory an indication that the window treatment system requires more or less lift assistance springs (e.g., that the window treatment system is not spring-balanced). For example, the control circuit may store in memory at 428 an indication that too many lift assistance springs are installed in the window treatment system. In addition, the control circuit may communicate at 428 an indication that too many lift assistance springs are installed, e.g., which may be an indication that the magnitude of the input power P_{IN} was greater than (e.g., greater than or equal to) the power threshold P_{TH} during the test procedure 400. For example, the control circuit may blink the visible indicator with a unique blink sequence that indicates that the window treatment system requires less lift assistance springs. Additionally or alternatively, the control circuit may transmit a message including the indication that too many lift assistance springs are installed at 428 (e.g., via a communication circuit 325). After storing in memory the indication that too many lift assistance springs are installed at 428, the control circuit may again sample the battery-voltage sense signal V_{V-BATT} and/or the battery-current sense signal V_{I-BATT} at 416 and calculate the input power P_{IN} of the motor drive unit at 418.

When the covering material is at the destination position P_{DEST} (e.g., the fully-lowered position P_{LOWERED}) at 422 and the control circuit is done with movements at 430, the control circuit may determine at 434 if there is stored in memory an indication that too few lift assistance springs are installed in the window treatment system. When there is an indication that too few lift assistance springs are installed at 434, the control circuit may communicate at 436 an indication that too few lift assistance springs are installed in the window treatment system, e.g., which may be an indication that the magnitude of the input power P_{IN} was greater than (e.g., greater than or equal to) the power threshold P_{TH} during the full-raise movement of the test procedure 400, before the test procedure 400 ends at 444. For example, the control circuit may blink the visible indicator with a unique blink sequence that indicates that too few lift assistance springs are installed at 436. Additionally or alternatively, the control circuit may transmit a message including the indication that too many lift assistance springs are installed at 436 (e.g., via the communication circuit 325).

When there is not an indication that too few lift assistance springs are installed at 434, but there is an indication that too many lift assistance springs are installed at 438, the control circuit may communicate an indication that too many lift assistance springs are installed at 440, e.g., which may be an indication that the magnitude of the input power P_{IN} was greater than (e.g., greater than or equal to) the power threshold P_{TH} during the full-lower movement of the test procedure 400. The test procedure 400 may then end at 444. For example, the control circuit may blink the visible indicator with a unique blink sequence that indicates that too many lift assistance springs are installed at 440. When there is not an indication that too few lift assistance springs are installed at 434 or an indication that too many lift assistance springs are installed at 438, the control circuit may communicate an indication that the window treatment system is spring-balanced at 442 (e.g., by causing the visible indicator to blink a unique blink sequence and/or transmitting a message), before the test procedure 400 ends at 444. In some examples, the test procedure 400 may simply end at 444 when there is not an indication that too few lift assistance springs are installed at 434 or an indication that too many lift assistance springs are installed at 438 (e.g., the control circuit may not communicate an indication that the window treatment system is spring-balanced at 442).

While the test procedure 400 has been described with the control circuit first controlling the covering material through the full-raise movement, and then controlling the covering material through the full-lower movement, the control circuit could control the covering material through the full-lower movement first and then the full-raise movement. In addition, while the test procedure 400 has been described with the control circuit automatically controlling the covering material from the lowered position P_{LOWERED} to the raised position P_{RAISED} at 414 and automatically controlling the covering material from the raised position P_{RAISED} to the lowered position P_{LOWERED} at 432, the test procedure 400 may also be implemented with the technician manually causing the motor drive unit to move the covering material at 414 and 432. For example, the technician may cause the motor drive unit to start the test procedure at 410 (e.g., to enter a test mode) by actuating a button on a remote control device and actuating other buttons on the remote control device to cause the motor drive unit to move through the full-raise movement and/or the full-lower movement.

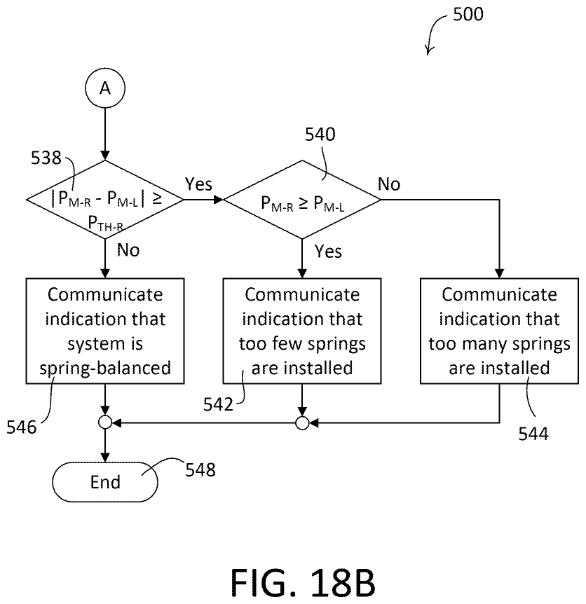

FIGS. 18A and 18B show a flowchart of another example test procedure 500 for verifying proper spring-balancing of a window treatment system (e.g., the Roman shade system 100 shown in FIGS. 1-3). The test procedure 500 may be executed by a control circuit (e.g., the control circuit 320) of a motor drive unit (e.g., the motor drive unit 160, 300). The motor drive unit may comprise a motor (e.g., the motor 310) configured to rotate a roller tube (e.g., the roller tube 122) of the window treatment system for adjusting a present position P_{PRES} of a covering material (e.g., the shade fabric 102) between a lowered position P_{LOWERED} (e.g., a fully-lowered position) and a raised position P_{RAISED} (e.g., a fully-raised position). The motor drive unit may be powered by one or more batteries (e.g., the batteries 154, 360). The window treatment system may comprise a lift assistance subsystem (e.g., the lift assistance subsystem 180) having one or more lift assistance springs (e.g., the lift assistance springs 182) for assisting the motor drive unit in raising and lowering the covering material. The test procedure 500 may be executed by the control circuit during a fabrication procedure (e.g., at 222 of the fabrication procedure 200) of the window treatment system. The test procedure 500 may be initiated by a technician (e.g., the technician carrying out the fabrication procedure 200). In addition, the test procedure 500 may be executed by the control circuit after installation of the window treatment system as the final installation site, and/or executed periodically as a maintenance process to determine if the spring-balancing of the window treatment system has changed over time.

The control circuit may start the test procedure 500 at 510 in response to receiving an input from the technician. For example, the control circuit may start the test procedure 500 at 510 in response to detecting an actuation of a button of the motor drive unit (e.g., the button on the end portion 165 of the motor drive unit 160 and/or the buttons that actuate the switching devices of the actuator circuit 326). In addition, the control circuit may start the test procedure 500 at 510 in response to receiving a message (e.g., in one or more wireless signals, such as radio-frequency signals) via a communication circuit (e.g., the communication circuit 325).

The control circuit may use variables, such as a maximum raising power P_{TH-R} and a maximum lowering power P_{M-L}, to keep track of a maximum input power when raising and lowering the covering material, respectively. At 512, the control circuit may initialize the maximum raising power P_{TH-R} and the maximum lowering power P_{M-L}, e.g., to zero Watts. At 514, the control circuit may control a motor drive circuit (e.g., the motor drive circuit 312) to drive the motor to adjust the present position P_{PRES} of the covering material to the lowered position P_{LOWERED}. For example, the control circuit may be configured to automatically adjust the present position P_{PRES} of the covering material to the fully-lowered position P_{LOWERED} after the test procedure 500 is started. In some examples, the technician may manually adjust the present position P_{PRES} of the covering material to the lowered position P_{LOWERED} prior to the start of the test procedure 500 (e.g., adjustment of the covering material at 514 may be omitted from the test procedure 500).

At 516, the control circuit may begin moving (e.g., automatically begin moving) the covering material to the raised position P_{RAISED} (e.g., to start a full-raise movement of the covering material). For example, the control circuit may set a destination position P_{DEST} equal to the raised position P_{RAISED} at 516. At 518, the control circuit may sample one or more sense signals of the motor drive unit during the movement, for example, using one or more analog-to-digital converters (ADCs). For example, the control circuit may sample a battery-current sense signal V_{I-BATT} that may indicate a magnitude of a battery current I_{BATT} conducted through the batteries to generate a battery-current sample S_{I-BATT} at 518. In addition, the control circuit may sample a battery-voltage sense signal V_{V-BATT} that may indicate a magnitude of a battery voltage V_{BATT} produced by the batteries to generate a battery-voltage sample S_{V-BATT} at 518.

At 520, the control circuit may determine a magnitude of an input power P_{IN} of the motor drive unit (e.g., a power consumed from the batteries) based on the battery-voltage sense signal V_{V-BATT} and the battery-current sense signal V_{I-BATT}. For example, the control circuit may be configured to calculate the magnitude of the input power P_{IN} by multiplying the battery-voltage sample S_{V-BATT} by the battery-current sense signal S_{I-BATT}, e.g., P_{IN}=(α·S_{V-BATT})·(β·S_{I-BATT}), where α and β are coefficients having values dependent upon the electrical circuitry used to generate the battery-voltage sense signal V_{V-BATT} and the battery-current sense signal V_{I-BATT}, respectively. In some examples, the control circuit may determine the magnitude of the input power P_{IN} of the motor drive unit (e.g., a power consumed from the batteries) based on (e.g., based on only) the battery-current sense signal V_{I-BATT} (e.g., not based on the battery-voltage sense signal V_{V-BATT}). For example, the control circuit may be configured such that the magnitude of the battery voltage V_{BATT} is a predetermined constant value, and may calculate the magnitude of the input power P_{IN} by multiplying the predetermined constant value of the battery voltage V_{BATT} by the battery-current sense signal S_{I-BATT}.

When the control circuit is presently raising the covering material at 522, the control circuit may determine if the magnitude of the input power P_{IN} is greater than (e.g., greater than or equal to) the maximum raising power P_{M-R} at 524. When magnitude of the input power P_{IN} is greater than (e.g., greater than or equal to) the maximum raising power P_{M-R} as the covering material is raising at 524, the control circuit may set the maximum raising power P_{M-R} equal to the present magnitude of the input power P_{IN} at 526. In some examples, the control circuit may compare the magnitude of the battery current I_{BATT} (e.g., the battery-current sample S_{I-BATT}) to a variable, such as a maximum raising current, as the covering material is raising at 524 and set the maximum raising current equal to the magnitude of the battery current I_{BATT} at 526 (e.g., if the control circuit is not configured to receive the battery-voltage sense signal V_{V-BATT}).

At 532, the control circuit may determine if the covering material is at the destination position P_{DEST} (e.g., as set at 516). For example, the control circuit may determine that the covering material is at the destination position P_{DEST} if the present position P_{PRES} of the covering material is equal to the destination position P_{DEST} at 532. When the covering material is not at the destination position P_{DEST} at 532, the control circuit may continue to sample the battery-voltage sense signal V_{V-BATT} and/or the battery-current sense signal V_{I-BATT} at 518 and calculate the input power P_{IN} of the motor drive unit at 520.

When the covering material is at the destination position P_{DEST} at 532, the control circuit may determine at 534 if the control circuit is done with movements of the covering material during the test procedure 500 (e.g., if the control circuit has moved the covering material through both the full-raise movement and the full-lower movement during the test procedure 500). If the control circuit is not done with movements (e.g., if the control circuit has only moved the covering material through the full-raise movement) at 534, the control circuit may begin moving the covering material to the fully-lowered position P_{LOWERED} (e.g., to start a full-lower movement of the covering material) at 536. For example, the control circuit may set a destination position P_{DEST} equal to the fully-lowered position P_{LOWERED} at 536. During the full-lower movement, the control circuit may sample the battery-voltage sense signal V_{V-BATT} and/or the battery-current sense signal V_{I-BATT} at 518 and calculate the input power P_{IN} of the motor drive unit at 520. When the control circuit is not presently raising the covering material (e.g., the control circuit is lowering the covering material) at 522, the control circuit may determine if the magnitude of the input power P_{IN} is greater than (e.g., greater than or equal to) the maximum lowering power P_{M-L} at 528. When magnitude of the input power P_{IN} is greater than (e.g., greater than or equal to) the maximum lowering power P_{M-L} as the covering material is lowering at 528, the control circuit may set the maximum lowering power P_{M-L} equal to the present magnitude of the input power P_{IN} at 530. In some examples, the control circuit may compare the magnitude of the battery current I_{BATT} (e.g., the battery-current sample S_{I-BATT}) to a variable, such as a maximum lowering current, as the covering material is lowering at 528 and set the maximum lowering current equal to the magnitude of the battery current I_{BATT} at 530 (e.g., if the control circuit is not configured to receive the battery-voltage sense signal V_{V-BATT}).

When the covering material is at the destination position P_{DEST} (e.g., the fully-lowered position P_{LOWERED}) at 532 and the control circuit is done with movements at 534, the control circuit may determine at 538 if there are too few or too many lift assistance springs installed in the window treatment system. The control circuit may determine that there are too few or too many lift assistance springs installed in the window treatment system when, for example, the difference between the maximum raising power P_{M-R} and the maximum lowering power P_{M-L} is greater than (e.g., greater than or equal to) a relative power threshold P_{TH-R} (e.g., approximately 1.5 Watts). For example, the control circuit may be configured to determine the difference between the maximum raising power P_{M-R} and the maximum lowering power P_{M-L} by calculating an absolute value of a subtraction of the maximum lowering power P_{M-L} from the maximum raising power P_{M-R} or an absolute value of a subtraction of the maximum raising power P_{M-R} from the maximum lowering power P_{M-L}.

If the difference between the maximum raising power P_{M-R} and the maximum lowering power P_{M-L} is greater than (e.g., greater than or equal to) the relative power threshold P_{TH-R} at 538, the control circuit may communicate an indication that the window treatment system requires more or less lift assistance springs (e.g., at 542 or 544). For example, at 540, the control circuit may determine if the maximum raising power P_{M-R} is greater than (e.g., greater than or equal to) the maximum lowering power P_{M-L}. If the maximum raising power P_{M-R} is greater than (e.g., greater than or equal to) the maximum lowering power P_{M-L} at 540, the control circuit may determine that too few lift assistance springs are installed in the window treatment system, and may communicate at 542 an indication that too few lift assistance springs are installed in the window treatment system (e.g., an indication that the difference between the maximum raising power P_{M-R} and the maximum lowering power P_{M-L} is greater than the relative power threshold P_{TH-R}, and that the maximum raising power P_{M-R} is greater than the maximum lowering power P_{M-L}), before the test procedure 500 ends at 548. For example, the control circuit may blink the visible indicator with a unique blink sequence that indicates that too few lift assistance springs are installed at 542. Additionally or alternatively, the control circuit may transmit a message including the indication that too many lift assistance springs are installed at 542 (e.g., via the communication circuit 325).

When the maximum raising power P_{M-R} is not greater than (e.g., greater than or equal to) the maximum lowering power P_{M-L} at 540 (e.g., the maximum lowering power P_{M-L} is less than the maximum lowering power P_{M-L}), the control circuit may determine that there are too many lift assistance springs installed in the window treatment system, and may communicate at 544 an indication that too many lift assistance springs are installed (e.g., an indication that the difference between the maximum raising power P_{M-R} and the maximum lowering power P_{M-L} is greater than the relative power threshold P_{TH-R}, and that the maximum lowering power P_{M-L} is less than the maximum lowering power P_{M-L}), before the test procedure 500 ends at 548. For example, the control circuit may blink the visible indicator with a unique blink sequence that indicates that too many lift assistance springs are installed at 544.

When the difference between the maximum raising power P_{M-R} and the maximum lowering power P_{M-L} is not greater than (e.g., greater than or equal to) the relative power threshold P_{TH-R} at 538 (e.g., the difference between the maximum raising power P_{M-R} and the maximum lowering power P_{M-L} is less than the relative power threshold P_{TH-R}), the control circuit may determine that there are not too few or too many lift assistance springs installed in the window treatment system, and may communicate an indication that the window treatment system is spring-balanced at 546 (e.g., by causing the visible indicator to blink a unique blink sequence and/or transmitting a message), before the test procedure 500 ends at 548. In some examples, the test procedure 500 may simply end at 548 when the difference between the maximum raising power P_{M-R} and the maximum lowering power P_{M-L} is less than the relative power threshold P_{TH-R} at 538 (e.g., the control circuit may not communicate an indication that the window treatment system is spring-balanced at 546).

While the test procedure 500 has been described with the control circuit first controlling the covering material through the full-raise movement, and then controlling the covering material through the full-lower movement, the control circuit could control the covering material through the full-lower movement first and then the full-raise movement. In addition, while the test procedure 500 has been described with the control circuit automatically controlling the covering material from the lowered position P_{LOWERED} to the raised position P_{RAISED} at 516 and automatically controlling the covering material from the raised position P_{RAISED} to the lowered position P_{LOWERED} at 536, the test procedure 500 may also be implemented with the technician manually causing the motor drive unit to move the covering material at 516 and 536. For example, the technician may cause the motor drive unit to start the test procedure at 510 (e.g., to enter a test mode) by actuating a button on a remote control device and actuating other buttons on the remote control device to cause the motor drive unit to move through the full-raise movement and/or the full-lower movement.

Although the present disclosure has been described in relation to particular examples thereof, many other variations and modifications and other uses will become apparent to those skilled in the art. For example, although the assemblies, systems, and methods have been described in relation to Roman shades, it should be understood that the concepts may be applied to other types of window treatments, such as roller shades, Venetian blinds, and cellular shades, to list only a couple of possibilities. In addition, the motor drive unit described herein may be used in systems for raising and lowering other flexible materials (e.g., such as projection screens) and/or other covering structures (e.g., such as garage doors), and/or systems for lifting and lowering other types of objects.

What is claimed is:

1. A window treatment system comprising:
first and second brackets for mounting the window treatment system to a structure;
a covering material;
a motor drive unit operatively coupled to the covering material for adjusting a position of the covering material between a lowered position and a raised position;
one or more lift assistance springs configured to provide lift assistance to the motor drive unit; and
a battery holder configured to receive at least one battery for powering the motor drive unit;
wherein, during a test procedure, the motor drive unit is configured to:
control the position of the covering material through a movement between the lowered position and the raised position;
determine a magnitude of an input power of the motor drive unit as consumed from the at least one battery during the movement of the covering material between the lowered position and the raised position;
determine that the window treatment system requires more or less lift assistance springs based on the input power of the motor drive unit during the movement of the covering material between the lowered position and the raised position; and
in response to determining that the window treatment system requires more or less lift assistance springs, communicate an indication that the window treatment system requires more or less lift assistance springs.

2. The window treatment system of claim 1, wherein, during the test procedure, the motor drive unit is configured to:
control the covering material from the lowered position to the raised position;
determine a maximum raising power while the motor drive unit is controlling the covering material from the fully-lowered position to the fully-raised position;
control the covering material from the raised position to the lowered position; and
determine a maximum lowering power while the motor drive unit is controlling the covering material from the raised position to the lowered position.

3. The window treatment system of claim 2, wherein the motor drive unit is configured to determine that the window treatment system requires more or less lift assistance springs when a difference between the maximum raising power and the maximum lowering power is greater than a threshold.

4. The window treatment system of claim 3, wherein, when the maximum raising power is greater than the maximum lowering power, the indication that the window treatment system requires more or less lift assistance springs is an indication that the window treatment system requires more lift assistance springs, and, when the maximum lowering power is greater than the maximum raising power, the indication that the window treatment system requires more or less lift assistance spring is an indication that the window treatment system requires less lift assistance springs.

5. The window treatment system of claim 3, wherein the indication that the window treatment system requires more or less lift assistance springs is an indication that the difference between the maximum raising power and the maximum lowering power is greater than the threshold.

6. The window treatment system of claim 1, wherein, during the test procedure, the motor drive unit is configured to determine that the window treatment system requires more or less lift assistance springs when the magnitude of the input power is greater than a threshold during the movement of the covering material between the lowered position and the raised position.

7. The window treatment system of claim 6, wherein, during the test procedure, the motor drive unit is configured to control the covering material from the lowered position to the raised position, and determine the magnitude of the input power of the motor drive unit during the movement of the covering material from the lowered position to the raised position; and
wherein, when the magnitude of the input power is greater than the threshold during the movement of the covering material from lowered position to the raised position, the indication that the window treatment system requires more or less lift assistance springs is an indication that the window treatment system requires more lift assistance springs.

8. The window treatment system of claim 6, wherein, during the test procedure, the motor drive unit is configured to control the covering material from the raised position to the lowered position, and determine the magnitude of the input power of the motor drive unit during the movement of the covering material from the raised position to the lowered position; and
wherein, when the magnitude of the input power is greater than the threshold during the movement of the covering material from raised position to the lowered position, the indication that the window treatment system requires more or less lift assistance springs is an indication that the window treatment system requires less lift assistance springs.

9. The window treatment system of claim 6, wherein the indication that the window treatment system requires more or less lift assistance springs is an indication that the magnitude of the input power was greater than the threshold during the movement of the covering material between the lowered position and the raised position.

10. A motor drive unit for a system for raising and lowering a covering material, the system comprising one or more lift assistance springs configured to provide lift assistance to the motor drive unit and a battery holder configured to receive at least one battery for powering the motor drive unit, the covering material configured to be adjusted between a lowered position and a raised position, the motor drive unit comprising:
a motor configured to be operatively coupled to the covering material for adjusting a present position of the covering material in response to rotation of the motor; and
a control circuit configured to control the motor to rotate for adjusting the present position of the covering material;
wherein, during a test procedure, the control circuit is configured to:
control the motor to adjust the present position of the covering material through a movement between the lowered position and the raised position;
determine a magnitude of an input power of the motor drive unit as consumed from the at least one battery during the movement of the covering material between the lowered position and the raised position;
determine that the system requires more or less lift assistance springs based on the input power of the motor drive unit during the movement of the covering material between the lowered position and the raised position; and
in response to determining that the system requires more or less lift assistance springs, communicate an indication that the system requires more or less lift assistance springs.

11. The motor drive unit of claim 10, wherein, during the test procedure, the control circuit is configured to determine that the system requires more or less lift assistance springs when the magnitude of the input power is greater than a threshold during the movement of the covering material between the lowered position and the raised position.

12. The motor drive unit of claim 11, wherein, during the test procedure, the control circuit is configured to:
control the motor to adjust the present position of the covering material from the lowered position to the raised position;
determine the magnitude of the input power of the motor drive unit during the movement of the covering material from the lowered position to the raised position; and
communicate an indication that the system requires more lift assistance springs when the magnitude of the input power is greater than the threshold during the movement of the covering material from lowered position to the raised position.

13. The motor drive unit of claim 11, wherein, during the test procedure, the control circuit is configured to:
control the motor to adjust the present position of the covering material from the raised position to the lowered position;
determine the magnitude of the input power of the motor drive unit during the movement of the covering material from the raised position to the lowered position; and
communicate an indication that the system requires less lift assistance springs when the magnitude of the input power is greater than the threshold during the movement of the covering material from raised position to the lowered position.

14. The motor drive unit of claim 10, wherein, during the test procedure, the control circuit is configured to:
control the motor to adjust the present position of the covering material from the lowered position to the raised position;
determine a maximum raising power while the motor drive unit is controlling the motor to adjust the present position of the covering material from the lowered position to the raised position;
control the motor to adjusting the present position of the covering material from the raised position to the lowered position; and
determine a maximum lowering power while the motor drive unit is controlling the motor to adjust the present position of the covering material from the raised position to the lowered position;
wherein the control circuit is configured to determine that the system requires more or less lift assistance springs when a difference between the maximum raising power and the maximum lowering power is greater than a threshold.

15. The motor drive unit of claim 14, wherein, in response to determining that the difference between the maximum raising power and the maximum lowering power is greater than the threshold, the control circuit is configured to communicate an indication that the system requires more lift assistance springs when the maximum raising power is greater than the maximum lowering power, and communicate an indication that the system requires less lift assistance springs when the maximum lowering power is greater than the maximum raising power.

16. The motor drive unit of claim 10, further comprising:
one or more light sources for illuminating respective visible indicators of the motor drive unit;
wherein the control circuit is configure to control the one or more light sources to illuminate the respective visible indicators to communicate the indication that the system requires more or less lift assistance springs.

17. The motor drive unit of claim 10, further comprising:
a communication circuit configured to transmit messages;
wherein the control circuit is configured to transmit a message including the indication that the system requires more or less lift assistance springs.

18. A method of controlling a window treatment system for raising and lowering a covering material, the window treatment system comprising one or more lift assistance springs configured to provide lift assistance to the motor drive unit and a battery holder configured to receive at least one battery for powering the motor drive unit, the covering material configured to be adjusted between a lowered position and a raised position, the method comprising:
adjusting a present position of the covering material through a movement between the lowered position and the raised position;
determining a magnitude of an input power of the motor drive unit as consumed from the at least one battery during the movement of the covering material between the lowered position and the raised position;
determining that the window treatment system requires more or less lift assistance springs based on the input power of the motor drive unit during the movement of the covering material between the lowered position and the raised position; and
in response to determining that the window treatment system requires more or less lift assistance springs, communicating an indication that the window treatment system requires more or less lift assistance springs.

19. The method of claim 18, wherein:
adjusting a present position of the covering material through a movement between the lowered position and the raised position further comprises adjusting the present position of the covering material from the lowered position to the raised position, and adjusting the present position of the covering material from the raised position to the lowered position.

20. The method of claim 19, wherein determining a magnitude of an input power of the motor drive unit as consumed from the at least one battery further comprises:
determining the magnitude of the input power of the motor drive unit during the movement of the covering material from the lowered position to the raised position; and
determining the magnitude of the input power of the motor drive unit during the movement of the covering material from the raised position to the lowered position.

21. The method of claim 20, wherein determining that the window treatment system requires more or less lift assistance springs further comprises:
determining that the window treatment system requires more lift assistance springs when the magnitude of the input power is greater than the threshold during the movement of the covering material from lowered position to the raised position; and
determining that the window treatment system requires less lift assistance springs when the magnitude of the input power is greater than the threshold during the movement of the covering material from raised position to the lowered position.

22. The method of claim 21, wherein communicating an indication that the window treatment system requires more or less lift assistance springs further comprises:
communicating an indication that the window treatment system requires more lift assistance springs when the magnitude of the input power is greater than the threshold during the movement of the covering material from lowered position to the raised position; and
communicating an indication that the window treatment system requires less lift assistance springs when the magnitude of the input power is greater than the threshold during the movement of the covering material from raised position to the lowered position.

23. The method of claim 18, wherein determining a magnitude of an input power of the motor drive unit as consumed from the at least one battery further comprises:
determining a maximum raising power during the movement of the covering material from lowered position to the raised position; and
determining a maximum lowering power during the movement of the covering material from raised position to the lowered position.

24. The method of claim 23, wherein determining that the window treatment system requires more or less lift assistance springs further comprises determining that the window treatment system requires more or less lift assistance springs when a difference between the maximum raising power and the maximum lowering power is greater than a threshold.

25. The method of claim 24, wherein communicating an indication that the window treatment system requires more or less lift assistance springs further comprises:
communicating an indication that the system requires more lift assistance springs when the maximum raising power is greater than the maximum lowering power; and
communicating an indication that the system requires less lift assistance springs when the maximum lowering power is greater than the maximum raising power.

26. The method of claim 18, wherein communicating an indication that the window treatment system requires more or less lift assistance springs further comprises illuminating one or more visible indicators to communicate the indication that the window treatment system requires more or less lift assistance springs.

27. The method of claim 18, wherein communicating an indication that the window treatment system requires more or less lift assistance springs further comprises transmitting a message including the indication that the window treatment system requires more or less lift assistance springs.

28. At least one computer-readable storage medium having computer-executable instructions stored thereon that, when executed by a control circuit, cause the control circuit to:
control a motor of a motor drive unit to adjust a present position of a covering material through a movement between a lowered position and a raised position, the motor drive unit configured to receive lift assistance from one or more lift assistance springs and receive power from at least one battery;
determine a magnitude of an input power of the motor drive unit as consumed from the at least one battery during the movement of the covering material between the lowered position and the raised position;
determine that more or less lift assistance springs are required based on the input power of the motor drive unit during the movement of the covering material between the lowered position and the raised position; and
in response to determining that the more or less lift assistance springs are required, communicate an indication that the more or less lift assistance springs are required.

29. The at least one computer-readable storage medium of claim 28, the computer-executable instructions being further configured to cause the control circuit to:
determine that more or less lift assistance springs are required when the magnitude of the input power is greater than a threshold during the movement of the covering material between the lowered position and the raised position.

30. The at least one computer-readable storage medium of claim 29, the computer-executable instructions being further configured to cause the control circuit to:
control the motor to adjust the present position of the covering material from the lowered position to the raised position;
determine the magnitude of the input power of the motor drive unit during the movement of the covering material from the lowered position to the raised position; and
communicate an indication that the system requires more lift assistance springs when the magnitude of the input power is greater than the threshold during the movement of the covering material from lowered position to the raised position.

31. The at least one computer-readable storage medium of claim 29, the computer-executable instructions being further configured to cause the control circuit to:
control the motor to adjust the present position of the covering material from the raised position to the lowered position;
determine the magnitude of the input power of the motor drive unit during the movement of the covering material from the raised position to the lowered position; and
communicate an indication that the system requires less lift assistance springs when the magnitude of the input power is greater than the threshold during the movement of the covering material from raised position to the lowered position.

32. The at least one computer-readable storage medium of claim 28, the computer-executable instructions being further configured to cause the control circuit to:
control the motor to adjust the present position of the covering material from the lowered position to the raised position;
determine a maximum raising power while the motor drive unit is controlling the motor to adjust the present position of the covering material from the lowered position to the raised position;
control the motor to adjusting the present position of the covering material from the raised position to the lowered position;
determine a maximum lowering power while the motor drive unit is controlling the motor to adjust the present position of the covering material from the raised position to the lowered position; and
determine that more or less lift assistance springs are required when a difference between the maximum raising power and the maximum lowering power is greater than a threshold.

33. The at least one computer-readable storage medium of claim 32, the computer-executable instructions being further configured to cause the control circuit, in response to determining that the difference between the maximum raising power and the maximum lowering power is greater than the threshold, to:
communicate an indication that the system requires more lift assistance springs when the maximum raising power is greater than the maximum lowering power; and
communicate an indication that the system requires less lift assistance springs when the maximum lowering power is greater than the maximum raising power.

34.-127. (canceled)
